(19) United States
(12) Patent Application Publication
(10) Pub. No.: US 2026/0210437 A1
(43) Pub. Date: Jul. 23, 2026

(54) SNOWMOBILE

(71) Applicant: POLARIS INDUSTRIES INC., Medina, MN (US)

(72) Inventors: Lucas SALFER, Salol, MN (US); Cole MAXWELL, Roseau, MN (US); Ben WINKEL, Minneapolis, MN (US); Cory WIMPFHEIMER, Greenbush, MN (US)

(21) Appl. No.: 19/143,514

(22) PCT Filed: Oct. 12, 2023
(86) PCT No.: PCT/US2023/076745

§ 371 Date: Jun. 26, 2025

Related U.S. Application Data
(60) Provisional application No. 63/477,405, filed on Dec. 28, 2022.

(51) Int. Cl. F16H 61/02; B60T 1/10; F16H 59/14; F16H 59/36; F16H 59/44; F16H 61/662

(52) U.S. Cl. CPC F16H 61/0213; B60T 1/10; F16H 59/14; F16H 59/44; F16H 61/662; B60T 2270/60; B60Y 2200/252; F16H 2059/147; F16H 2059/366

(57) ABSTRACT

A method of auto-shifting a snowmobile transmission is provided. The method includes receiving a first indication. The first indication corresponds to torque of a motor. The method further includes receiving a second indication. The second indication corresponds to rotations per minute (RPM) of the motor. The method further includes calculating an efficiency of the motor, based on the first indication and the second indication, and shifting, automatically, from a first gear to a second gear, based on the calculated efficiency.

### CROSS-REFERENCE TO RELATED APPLICATIONS

The present application claims priority to U.S. Provisional Application No. 63/477,405, filed on Dec. 28, 2022, and entitled “SNOWMOBILE,” the entire disclosure of which is expressly incorporated by reference herein.

### FIELD

The present disclosure relates to vehicles, and in particular to vehicles with an endless track ground engaging member.

### BACKGROUND

Endless track vehicles include snowmobiles that have endless track rear ground engaging members and front skis.

### SUMMARY

Aspects of the present disclosure relate generally to a snowmobile, such as a gas-powered or electric snowmobile. In some examples, functionalities for the snowmobile may be automated, such as transmission shifting, regenerative breaking, and disarm or rearm functions for a throttle of the snowmobile.

In some examples, a method of auto-shifting a snowmobile transmission is provided. The method includes receiving a first indication. The first indication corresponds to a torque of a motor. The method further includes receiving a second indication. The second indication corresponds to rotations per minute (RPM) of the motor. The method further includes calculating an efficiency of the motor, based on the first indication and the second indication, and shifting, automatically, from a first gear to a second gear, based on the calculated efficiency.

Some examples further include, prior to shifting from the first gear to the second gear, determining that a speed of the snowmobile is less than a predetermined threshold.

In some examples, the predetermined threshold is between about 10 miles-per-hour and about 20 miles-per-hour.

In some examples, the first and second indications are received at a controller, and at least one of the first indication or the second indication are received via a controller area network (CAN).

In some examples, the shifting from the first gear to the second gear is configured to increase an efficiency of the motor.

In some examples, the first gear includes a high gear assembly, and the second gear includes a low gear assembly.

In some examples, the high and low gear assemblies each include a respective belt and plurality of sprockets.

In some examples, a snowmobile is provided. The snowmobile includes a plurality of ground engaging members, a structural frame, and an electric powertrain. The plurality of ground engaging members include an endless track and a plurality of front skis. The structural frame is supported by the plurality of ground engaging members. The electric powertrain is operatively coupled to the endless track to power movement of the endless track. The electric powertrain includes a controller. The controller includes one or more processors and memory storing instructions that when executed, by the one or more processors, cause the controller to execute a set of operations. The set of operations includes aspects of one or more of the examples provided herein.

In some examples, a snowmobile is provided. The snowmobile includes a plurality of ground engaging members that include an endless track and a plurality of front skis. The snowmobile further includes a structural frame that is supported by the plurality of ground engaging members, and a powertrain that is operatively coupled to the endless track to power movement of the endless track. The powertrain includes an engine that has an exhaust system, an intake system, a drive system that includes a continuously variable transmission (CVT), and a controller. The controller includes one or more processors and memory storing instructions that when executed, by the one or more processors, cause the controller to execute a set of operations. The set of operations includes aspects of one or more examples provided herein.

In some examples, a snowmobile transmission assembly is provided. The snowmobile transmission assembly includes an input shaft, an output shaft, a first gear assembly, a second gear assembly, and a selector. The first gear assembly includes a first sprocket, a second sprocket, and a first belt extending around the first sprocket and the second sprocket. The second gear assembly includes a third sprocket, a fourth sprocket, and a second belt extending around the third sprocket and the fourth sprocket. The selector is operatively coupled to the input shaft to engage one of the first gear assembly or the second gear assembly, via one of the second sprocket or the fourth sprocket. The input shaft extends through the second sprocket, the selector, and the fourth sprocket. Further, the output shaft extends through the first sprocket and the third sprocket.

In some examples, the output shaft is configured to rotate a drive shaft. The drive shaft is coupled to an endless track assembly.

In some examples, the input shaft is coupled to a torque converter.

In some examples, a ratio of the second gear assembly to the first gear assembly is greater than 1 and less than 5.

In some examples, a rotation of the input shaft is configured to rotate the drive shaft, via one of the first belt or the second belt.

In some examples, the selector is configured to automatically engage the first gear assembly or the second gear assembly, based on input received from a controller.

In some examples, a snowmobile is provided. The snowmobile includes a plurality of ground engaging members, a structural frame, an electric powertrain, and one or more battery assemblies. The plurality of ground engaging members include an endless track positioned along a vertical centerline plane of the snowmobile, a left front ski, and a right front ski. The endless track is positioned rearward of the left front ski and the right front ski. The structural frame is supported by the plurality of ground engaging members. The structural frame provides structural rigidity for the snowmobile. The structural frame includes a tunnel. The electric powertrain is operatively coupled to the endless track to power movement of the endless track. The electric powertrain includes an electric motor that is operatively coupled to the endless track. The one or more battery assemblies are operatively and removably coupled to the electric motor. The one or more battery assemblies are removably coupled to the structural frame. The one or more battery assemblies are configured for use as an external generator, when de-coupled from the structural frame and the electric motor.

In some examples, the one or more battery assemblies each include a rechargeable battery, a high voltage box, and a standard voltage box.

In some examples, the one or more battery assemblies each include one or more wheels.

Some examples further include an operator seat. The operator seat is supported by the structural frame. The one or more battery assemblies are configured to be coupled to the structural frame, between the tunnel and the operator seat.

In some examples, the one or more battery assemblies each include a handle. The handle is configured for a user to carry or roll each of the one or more battery assemblies.

In some examples, a method of generating electricity for a device, using one or more of the snowmobiles described herein, is provided. The method includes de-coupling the one or more battery assemblies from the structural frame, de-coupling the one or more battery assemblies from the electric motor, operatively coupling the device to the one or more battery assemblies, and transferring electricity to the device, from the one or more battery assemblies.

In some examples, a method of adjusting regenerative breaking for a snowmobile are provided. The method includes receiving a first indication. The first indication corresponds to a speed of the snowmobile. The method further includes receiving a second indication. The second indication corresponds to one or more of a pitch, yaw, or roll of the snowmobile. The method further includes determining a regenerative torque multiplier, based on the first indication and the second indication. The method further includes adjusting a degree of regenerative breaking, automatically, based on the regenerative torque multiplier.

In some examples, the second indication correspond to vehicle pitch.

In some examples, the second indication corresponds to an increased pitch of the snowmobile, the first indication corresponds to a decrease in the speed of the snowmobile, and the adjusting the degree of regenerative breaking corresponds to increasing the degree of regenerative breaking.

In some examples, the second indication corresponds to a decreased pitch of the snowmobile, the first indication corresponds to an increase in the speed of the snowmobile, and the adjusting the degree of regenerative breaking corresponds to decreasing the degree of regenerative breaking.

Some examples further include determining a regenerative torque slew rate multiplier, based on the first indication and the second indication, and adjusting the degree of regenerative breaking, at a rate corresponding to the regenerative torque slew rate multiplier.

In some examples, the first indication and the second indication are received by a controller.

In some examples, the first indication and the second indication are received from an inertial measurement unit (IMU), in real time.

In some examples a system is provided. The system includes one or more processors and memory storing instructions that when executed, by the one or more processors, cause the system to perform a method according to aspects of one or more methods described herein.

In some examples, a method of disarming a snowmobile is provided. The method include receiving a preconfigured duration of time, determining that one or more types of user-input have not been received, for the preconfigured duration of time, disarming the snowmobile, automatically, receiving an indication corresponding to rearming the snowmobile, and rearming the snowmobile.

In some examples, prior to receiving the indication, the method includes receiving an indication that corresponds to a throttle of the snowmobile being depressed, and not moving the snowmobile.

In some examples, after rearming the snowmobile, the method includes receiving an indication corresponding to a throttle of the snowmobile being depressed, and moving the snowmobile.

In some examples, the indication is received from a sensor of a key switch.

In some examples, the indication is received from the sensor of the key switch, when the key switch is in a momentary start position.

In some examples, the indication is received from a press of an engine start/stop button.

In some examples, the indication is received from a weight sensor. The weight sensor corresponds to an operator seat of the snowmobile.

In some examples, disarming the snowmobile includes blocking a signal from being sent, via a controller to an electric motor, to throttle the electric motor.

In some examples, the one or more types of user-input include one or more of pressing a button or turning a lever, corresponding to an increase in throttle.

In some examples, a method of swapping batteries is provided. The method includes providing a vehicle. The vehicle include a plurality of ground engaging members, a structural frame, an electric powertrain, and a first battery assembly. The plurality of ground engaging members include an endless track positioned along a vertical centerline plane of the vehicle, a left front ski, and a right front ski. The electric powertrain is operatively coupled to the endless track to power movements of the endless track. The electric powertrain includes an electric motor operatively coupled to the endless track. The first battery assembly is operatively and removably coupled to the electric motor, and the first battery assembly is removably coupled to the structural frame. The method further includes determining a charge level of the first battery assembly is below a predetermined threshold, providing an indication that correspond to the charge level being below the predetermined threshold, and in response to providing the indication, receiving a second battery assembly in replacement of the first battery assembly.

In some examples, the first battery assembly includes a first traction battery, and the second battery assembly includes a second traction battery.

In some examples, the second battery assembly is operatively and removably coupled to the electric motor and removably coupled to the structural frame.

In some examples, prior to second battery assembly being received, and in response to providing the indication, the first battery assembly is de-coupled from the electric motor and the structural frame.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 illustrates a left side view of an exemplary snowmobile.

FIG. 2 illustrates a left side view of a structural frame of the snowmobile of FIG. 1.

FIG. 3 illustrates a right side view of the exemplary snowmobile of FIG. 1.

FIG. 4 illustrates a top view of the exemplary snowmobile of FIG. 1.

FIG. 5 illustrates a top view of the exemplary frame of FIG. 2.

FIG. 6 illustrates an exemplary electric powertrain assembly of the exemplary snowmobile of FIG. 1.

FIG. 7 illustrates an exemplary motor assembly of the exemplary electric powertrain assembly of FIG. 6.

FIG. 8 illustrates an exemplary battery assembly of the exemplary electric powertrain assembly of FIG. 6.

FIG. 9 illustrates a top, front, and right side view of a transmission, according to some aspects described herein.

FIG. 10 illustrates a cross-sectional view of the transmission of FIG. 9, taken along section 10-10.

FIG. 11 illustrates a cross sectional view of the transmission of FIG. 9, taken along section 10-10.

FIG. 12 illustrates an example transmission shift, based on operating points, according to some aspects described herein.

FIG. 13 illustrate an example method for auto shifting a transmission, according to some aspects described herein.

FIG. 14 illustrates an example of a battery assembly operably coupled to a snowmobile, according to some aspects described herein.

FIG. 15 illustrates an example of the battery assembly of FIG. 14 de-coupled from a snowmobile, according to some aspects described herein.

FIG. 16 illustrates an example method of generating electricity for a device, using a snowmobile.

FIG. 17 illustrates an example snowmobile on an incline, according to some aspects described herein.

FIG. 18 illustrates an example plot of a plurality of regenerative torque multipliers, according to some aspects described herein.

FIG. 19 illustrates an example plot of a plurality of regenerative torque slew rate multipliers, according to some aspects described herein.

FIG. 20 illustrates an example method of adjusting regenerative breaking for a snowmobile, according to some aspects described herein.

FIG. 21 illustrates an example method of disarming a snowmobile, according to some aspects described herein.

FIG. 22 illustrates an example system according to some aspects described herein.

Corresponding reference characters may indicate corresponding parts throughout the several views. Unless stated otherwise the drawings are proportional and drawn to scale.

### DETAILED DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Further, throughout the disclosure, the terms “about”, “substantially”, and “approximately” mean plus or minus 5% of the number or geometric constraint that each term precedes. For example, about 100 may mean 100 +/5. Additionally, or alternatively, substantially orthogonal may mean that any 90 degree angle related to the described orthogonality may be between 85.5 degrees and 94.5 degrees (inclusive).

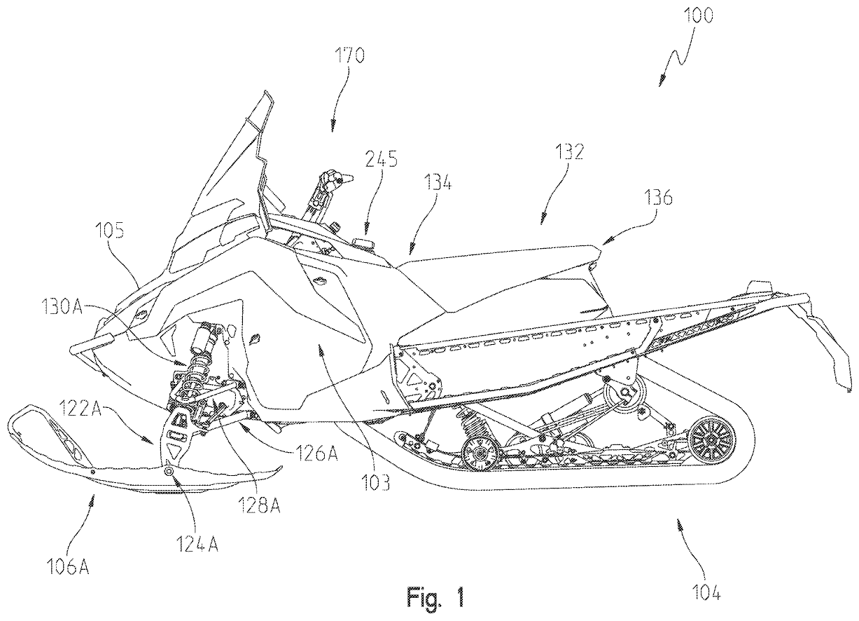

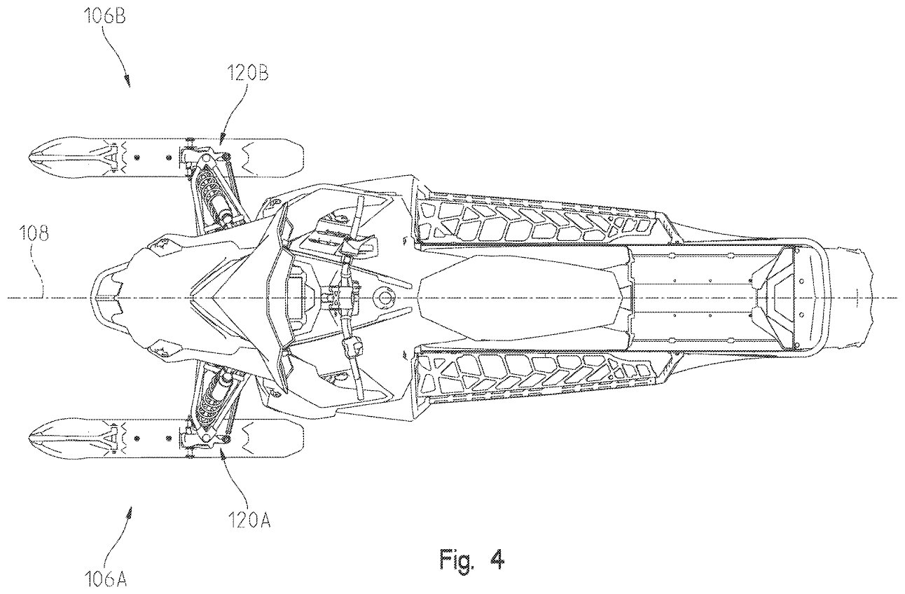

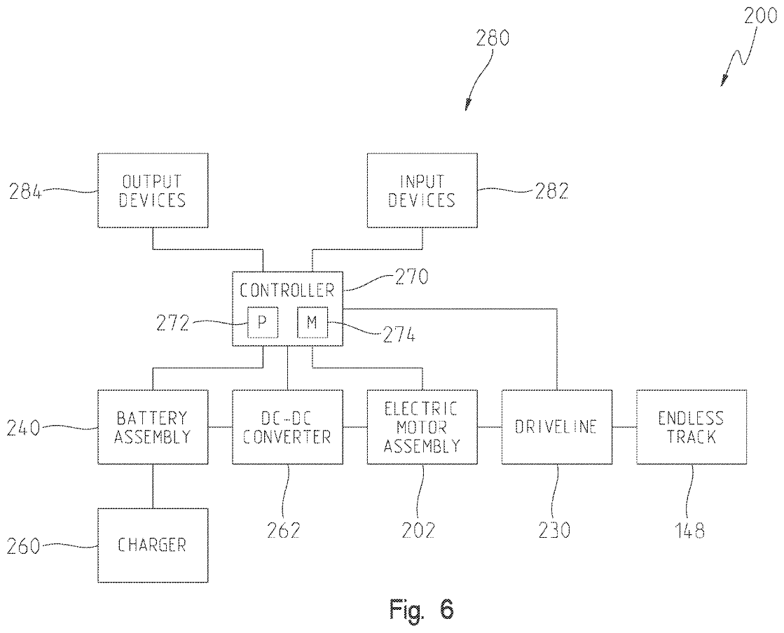

Referring to FIG. 1, an illustrated embodiment of snowmobile 100 is shown. Snowmobile 100 as illustrated includes a body 103, a plurality of ground engaging members, such as an endless track assembly 104, and a pair offront skis 106A and 106B (see FIG. 4). Endless track assembly 104 supports a rear portion of snowmobile 100 while skis 106 support a front portion of snowmobile 100. Further, endless track assembly 104 is operatively coupled to an electric powertrain assembly 200 (see FIG. 6). Snowmobile 100 further includes a hood 105.

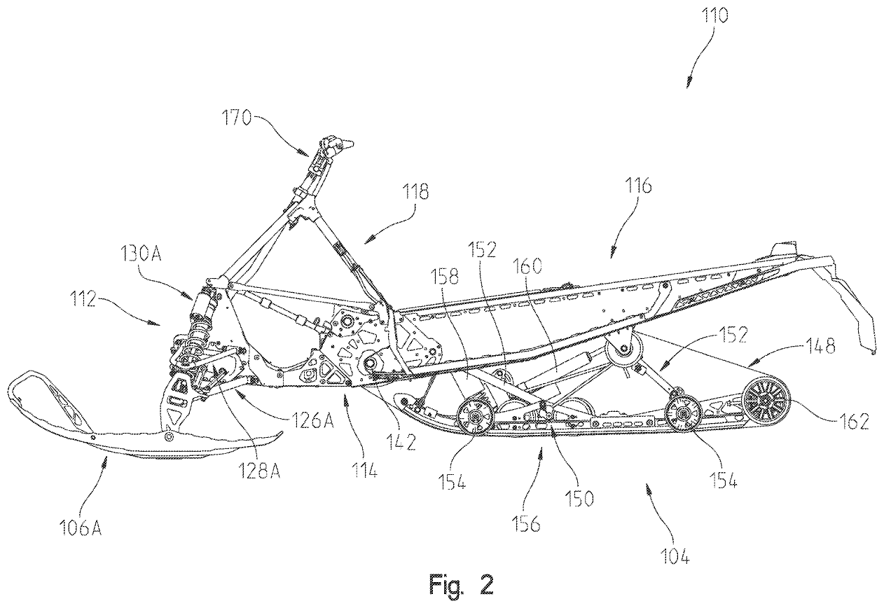

Referring to FIG. 2, snowmobile 100 includes a structural frame 110. Structural frame 110 includes a front frame portion 112 which is generally supported by one or more skis 106, such as a first ski 106A and a second ski 106B. Structural frame 110 further includes a tunnel 116 which is generally supported by endless track assembly 104 and a middle frame portion 114 connecting front frame portion 112 and tunnel 116. Additionally, structural frame 110 may include an overstructure 118 which supports a steering assembly 170 of snowmobile 100. In the illustrated embodiment, front frame portion 112, middle frame portion 114, tunnel 116, and overstructure 118 are coupled together with fasteners, weldments, adhesives, or other suitable couplers. In some examples, one or more of front frame portion 112, middle frame portion 114, tunnel 116, and overstructure 118 are integrally formed with another of front frame portion 112, middle frame portion 114, tunnel 116, and overstructure 118. Exemplary frames are disclosed in U.S. Pat. No. 8,490,731 titled SNOWMOBILE, the entire disclosure of which is expressly incorporated by reference herein.

Each of front frame portion 112, middle frame portion 114, tunnel 116, and overstructure 118 is a part of structural frame 110. Structural frame 110 provides structural rigidity for snowmobile 100. As explained herein each of front frame portion 112, middle frameportion 114, tunnel 116, overstructure 118 may support one or more portions of electric powertrain assembly 200. Further, as explained herein, one or more portions of electric powertrain assembly 200 may be part of the structural frame of snowmobile 100. For example, one or more portions of electric powertrain assembly 200 may replace a component of one or more of front frame portion 112, middle frame portion 114, tunnel 116, and overstructure 118, be interposed between the components of one or more of front frame portion 112, middle frame portion 114, tunnel 116, and overstructure 118, be interposed between two or more of front frame portion 112, middle frame portion 114, tunnel 116, and overstructure 118, and/or being integrally formed as part of one or more of front frame portion 112, middle frame portion 114, tunnel 116, and overstructure 118.

Referring back to FIG. 1, structural frame 110 supports an operator seat 132. Operator seat 132 has a front end 134 and a rear end 136, front end 134 being positioned closer to skis 106 than rear end 136. Further, operator seat 132 is positioned rearward of a steering assembly 170 of snowmobile 100.

Front frame portion 112 is coupled to first and second skis 106A and 106B through respective front suspensions 120A and 120B (see FIG. 4). Front suspensions 120A and 120B each permits the relative movement of structural frame 110 relative to skis 106. In general, front suspension 120B is a mirror image of front suspension 120A.

Still referring to FIG. 1, front suspension 120A includes a spindle 122A which is rotatably coupled to front skis 106A at a lower end. Spindle 122A is further rotatably coupled to a lower control arm 126A and an upper control arm 128A. Lower control arm 126A and upper control arm 128A are each rotatably coupled to front frame portion 112 of structural frame 110 (see FIG. 2). A shock absorber 130A is rotatably coupled to one of lower control arm 126A and upper control arm 128A and to front frame portion 112 of structural frame 110. Shock absorbers 130, in some examples, may be electronically controlled shock absorber having adjustable compression and/or rebound damping characteristics. Additional details regarding exemplary electronically controlled shock absorber systems are described in U.S. patent application Ser. No. 17/325,062, filed May 19, 2021, titled SYSTEMS AND METHODS OF ADJUSTABLE SUSPENSIONS FOR OFF-ROAD RECREATIONAL VEHICLES, the entire disclosure of which is expressly incorporated by reference herein.

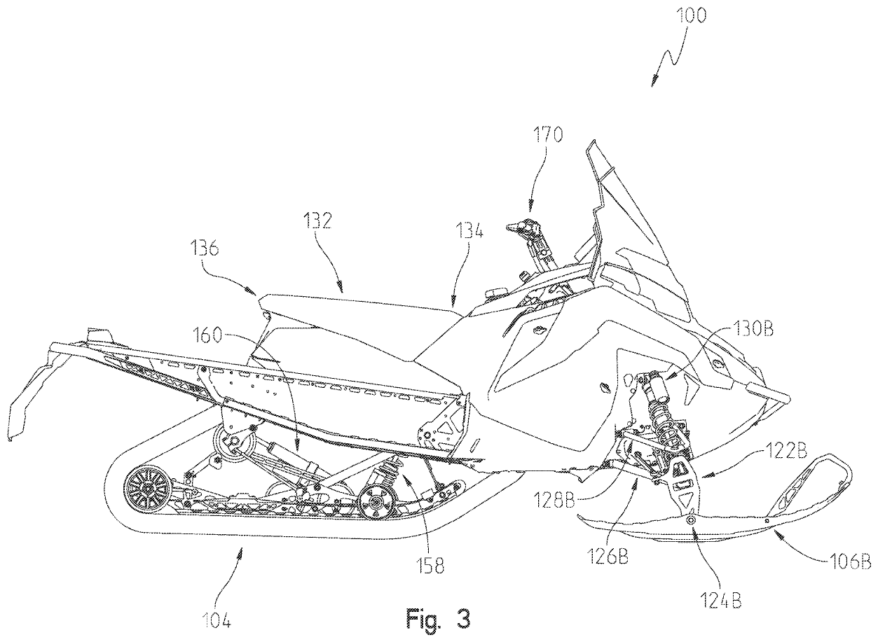

Referring to FIG. 3, structural frame 110 is supported by endless track assembly 104 through a rear suspension 140. In the illustrated embodiment, rear suspension 140 of endless track assembly 104 includes a plurality of slide rails 150, a plurality of control arms 152 rotatably coupled to the plurality of slide rails 150 and rotatably coupled to tunnel 116 of structural frame 110, a plurality of idler wheels 154 coupled to the plurality of slide rails 150, and at least one shock absorber 156, illustratively front shock absorber 158 and rear shock absorber 160. Further, rear suspension 140 includes tensioning wheels 162. One or both of front shock absorber 158 and rear shock absorber 160, in some examples, may be an electronically controlled shock absorber having adjustable compression and/or rebound damping characteristics. Additional details regarding exemplary electronically controlled shock absorber systems are described in U.S. patent application Ser. No. 17/325,062, filed May 19, 2021, titled SYSTEMS AND METHODS OF ADJUSTABLE SUSPENSIONS FOR OFF-ROAD RECREATIONAL VEHICLES, the entire disclosure of which is expressly incorporated by reference herein.

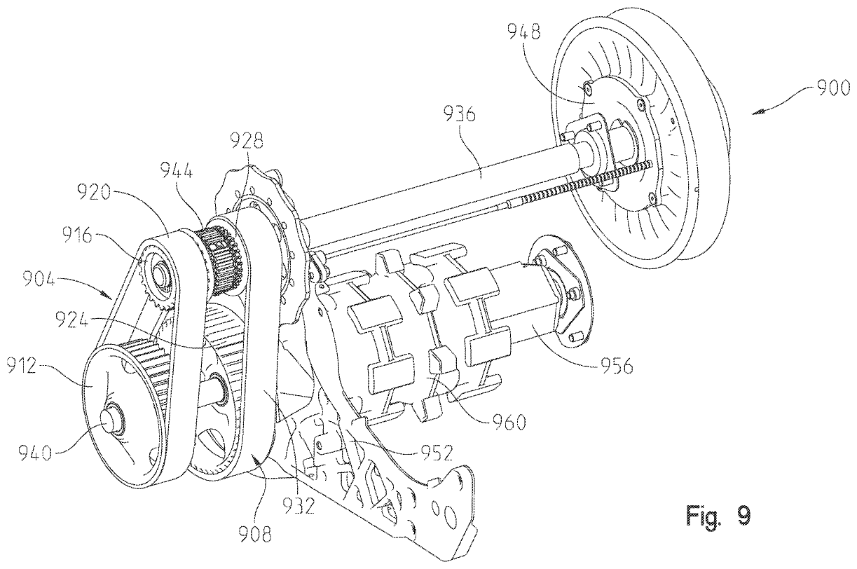

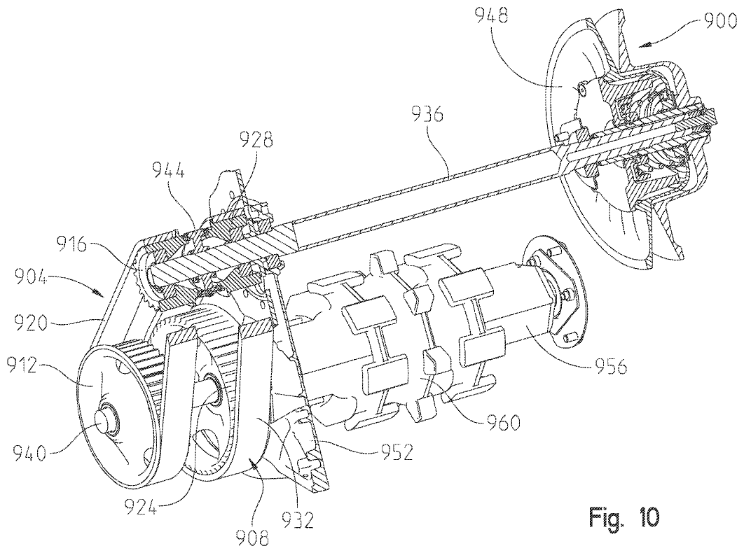

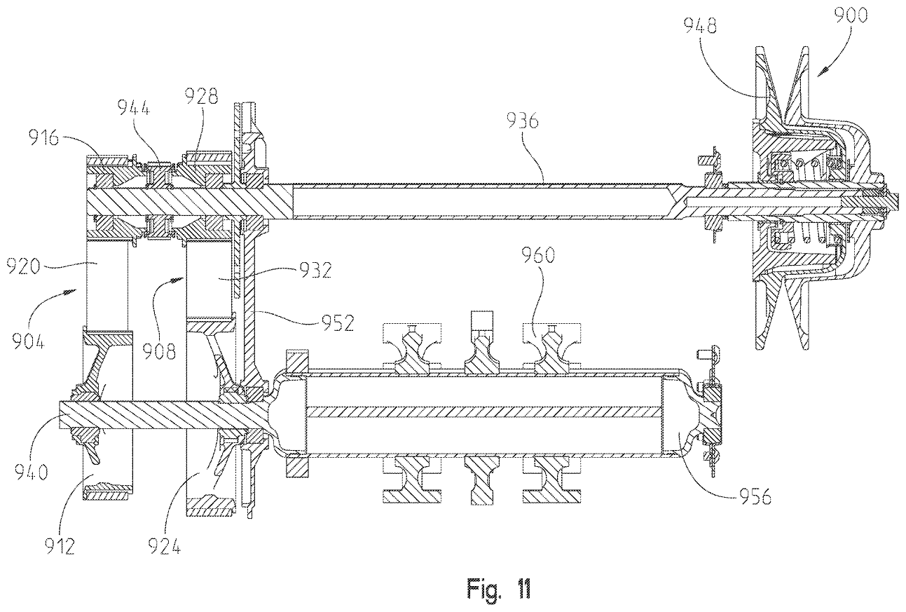

A drive shaft 142 (see FIG. 2) is accessible of an outside of tunnel 116 and extends through an interior of tunnel 116. Drive shaft 142 includes at least one drive sprocket which has a plurality of engagement features, such as teeth, to engage and move endless track belt 148 of endless track assembly 104. Drive shaft 142 is rotatably coupled to structural frame 110 and couples endless track assembly 104 to an electric motor 202 of snowmobile 100. In embodiments, drive shaft 142 may be similar to the drive shaft discussed later herein with respect to FIGS. 9-11.

FIG. 4 illustrates a top view of the exemplary snowmobile 100. As shown in FIG. 4, the snowmobile 100 defines a longitudinal vertical plane 108. In some examples, the snowmobile 100 is substantially symmetrical across the longitudinal vertical plane. For example, as shown in FIG. 4, the longitudinal vertical plane 108 extends equidistant between the front skis 106A, 106B. The front suspensions 120A, 120B extend from a respective one of the front skis 106A, 106B, toward the longitudinal vertical plane 108.

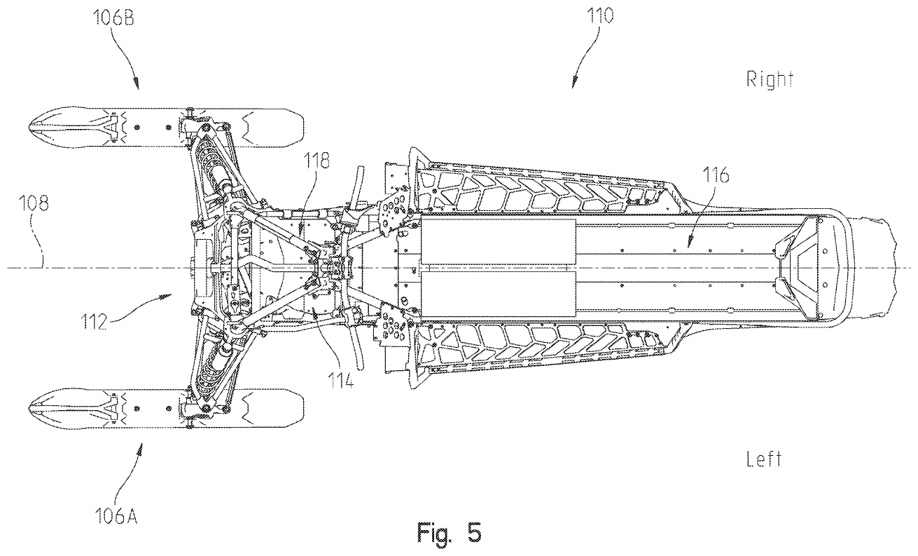

FIG. 5 illustrates a top view of the exemplary frame 110. The tunnel 116 of the frame 110 extends longitudinally along the longitudinal vertical plane 108. Generally, the longitudinal vertical plane 108 divides the frame 110 into a right side and a left side. The right side of the frame 110 may be symmetrical to the left side of the frame 110, across the longitudinal vertical plane 108.

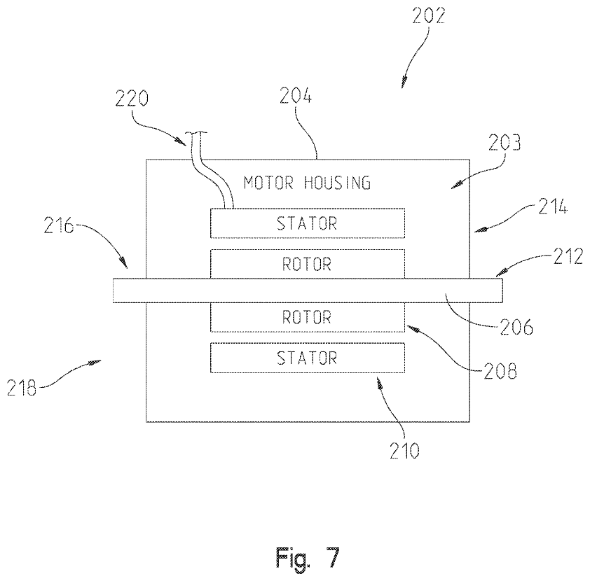

In some examples, snowmobile 100 is powered for movement relative to the ground with an electric powertrain assembly. Referring to FIG. 6, an exemplary electric powertrain assembly 200 is shown. Electric powertrain assembly 200 includes at least one electric motor assembly 202 including an electric motor 203 (see FIG. 7). Referring to FIG. 7, electric motor assembly 202 includes a motor housing 204 in which is positioned electric motor 203 including a drive shaft 206 supporting a rotor 208 and a stator 210. Drive shaft 206 includes a first end 212 which extends beyond a first end 214 of motor housing 204 and optionally a second end 216 which extends beyond a second end 218 of motor housing 204, second end 218 is opposite of first end 214. In some examples, electric motor assembly 202 further includes an electronic controller that controls the operation of electric motor 203. Electric motor 203 receives electrical power through electrical connectors 220.

Returning to FIG. 6, electric motor assembly 202 is operatively coupled to a drive sprocket of endless track assembly 104 through a driveline 230. In some examples, electric motor assembly 202 is positioned within the interior of endless track belt 148. In some examples, electric motor assembly 202 is supported by structural frame 110 and coupled to drive shaft 142 through one or more of a gearset, a continuously variable transmission (CVT), a chain drive, other suitable coupling devices which transfer mechanical power, and/or combinations thereof.

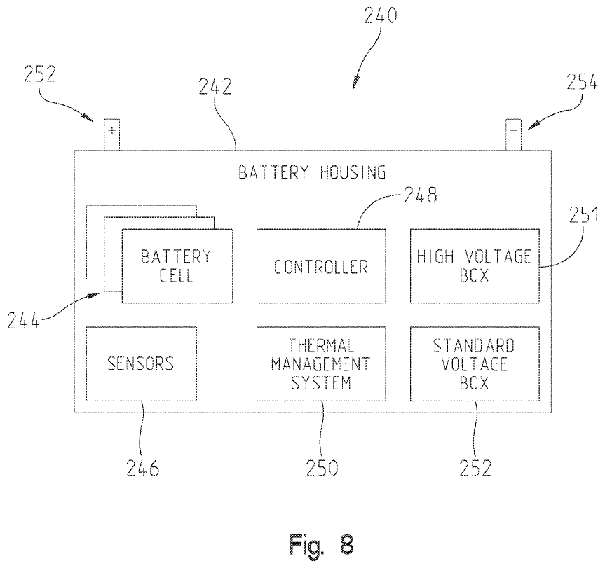

Electric motor assembly 202 receives electrical energy from at least one battery assembly 240. In some examples, a plurality of battery assemblies 240 are provided. Referring to FIG. 8, battery assembly 240 includes a battery housing 242 in which are positioned a plurality of battery cells or battery pouches 244. Exemplary battery cells may be prismatic, cylindrical, or other suitable shapes. Exemplary battery cells include lithium-ion cells, nickel-cadmium cells, and other suitable cell chemistries. Battery assembly 240 may optionally include one or more of sensors 246, an electronic controller 248, a thermal management system 250, a high voltage box 251, and/or a standard voltage box 252.

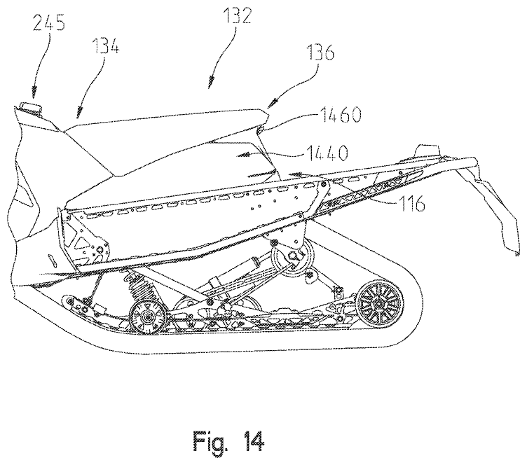

The one or more battery cells 244 may be rechargeable, thereby forming a rechargeable battery. Additionally, or alternatively, the high voltage box 251 and/or the standard voltage box 252 may be used for supplying electricity to any of a variety of different electronic devices (as discussed further herein with respect to FIGS. 14-16).

In some examples, the electric motor assembly 202 may be replaced by an engine assembly that includes an engine with an exhaust system, an intake system, and a drive system. The drive system may include a continuously variable transmission (CVT). Such a configuration may be described further with respect to U.S. Pat. No. 10,035,554, entitled “SNOWMOBILE”, and/or U.S. Pat. No. 11,110,994, also entitled “SNOWMOBILE”, which are hereby incorporated by reference in their entirety. It should be recognized that in some examples, the electric motor assembly 202 may not include a CVT because torque can be increased relatively quickly with an electric motor assembly, without having to amplify the torque, for example, via a CVT.

Sensors 246 may monitor characteristics associated with one or more of battery cells 244. Exemplary characteristics include temperature, charge, current, voltage, resistance, and other suitable characteristics. Electronic controller 248 controls the operation of battery cells 244 including charging and discharging. In some examples, battery assembly 240 includes one or more switches which electronic controller 248 controls to selectively charge at least a portion of battery cells 244 and/or selectively discharge at least a portion of battery cells 244.

Thermal management system 250 controls the temperature of battery cells 244. In some examples, thermal management system 250 removes heat from proximate battery cells 244 to lower or reduce a rate of increase in a temperature of battery cells 244. In some examples, thermal management system 250 provides heat to proximate battery cells 244 to raise the temperature of battery cells 244, such as during cold weather operation. Exemplary thermal management system 250 include passive systems, such as plates, heat sinks, and active systems including fluid systems to enhance removal and/or supply of heat. Exemplary active systems include air systems wherein air is directed over plates, heat sinks, or fluid conduits positioned proximate to battery cells 244 and liquid systems wherein a liquid fluid is directed through fluid conduits proximate to battery cells 244.

The plurality of battery cells 244 are electrically coupled together in series, in parallel, or in a combination of portions in series and portions in parallel. The plurality of battery cells 244 are electrically coupled to a positive terminal 253 of battery assembly 240 and a negative terminal 254 of battery assembly 240 both of which are accessible from an exterior of battery housing 242.

Battery assembly 240 may be operatively coupled to a charger 260 to charge battery cells 244. An exemplary charge port 245 (see FIG. 1) may be positioned where a gas cap would be on a gas-powered snowmobile or other suitable locations. Further, battery assembly 240 may be operatively coupled to a DC-DC converter 262 which controls the power level provided to electric motor assembly 202. In some examples, the DC-DC converter 262 provides power to the electric motor assembly 202 at a different voltage than the battery assembly 240 provides power to the electric motor assembly 202. Further, in some examples, an inverter or motor controller may be programmed or otherwise configured to control a power level provided to the electric motor assembly 202 (e.g., to the electric motor 203 of the electric motor assembly 202). In some examples, electric motor 203 of electric motor assembly 202 is a DC motor. In some examples, electric motor 203 of electric motor assembly 202 is an AC motor (e.g., a 3-phase motor) and an inverter or controller through which power is provided in addition to or in place of DC-DC converter 262. In some examples, the electric motor 203 may be any other type of motor that may be recognized by those of ordinary skill in the art.

In some examples, either DC-DC converter 262 or a second DC-DC converter receives power from battery assembly 240 and is converted to either AC accessory power or DC accessory power. In some examples, at least one plug is provided to connect accessories, such as ice augers, stereos, heaters, cooling devices, computer, and a heater for battery assembly 240.

Referring again to FIG. 6, electric powertrain assembly 200 further includes an electronic controller 270. Electronic controller 270 includes at least one processor 272 and at least one non-transitory computer readable medium, memory 274. In some examples, electronic controller 270 is a single unit that controls the operation of various systems of electric powertrain assembly 200 and optionally snowmobile 100. In some examples, electronic controller 270 is a distributed system comprised of multiple controllers each of which control one or more systems of electric powertrain assembly 200 and optionally snowmobile 100 and may communicate with each other over one or more wired and/or wireless networks.

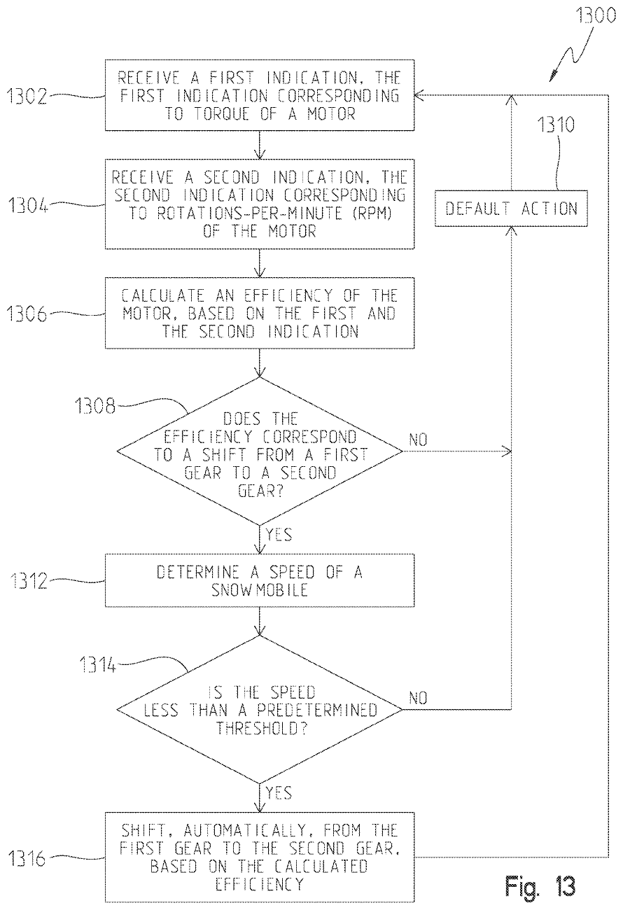

Electronic controller 270 includes logic, such as processing sequences corresponding to methods 1300, 1600, 2000, and/or 2100 of FIGS. 13, 16, 17, 20, and 21, which can control the operation of snowmobile 100. Further, memory 274 may include one or more configuration settings for electronic controller 270. The configuration settings may be used by the logic in the control of electric powertrain assembly 200 or other components and systems of snowmobile 100, such as shock absorbers 130, 158, and/or 160.

The term “logic” as used herein includes software and/or firmware executing on one or more programmable processors, application-specific integrated circuits, field-programmable gate arrays, digital signal processors, hardwired logic, or combinations thereof. Therefore, in accordance with some examples, various logic may be implemented in any appropriate fashion and would remain in accordance with some examples herein disclosed.

The non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein.

This disclosure contemplates other examples in which electronic controller 270 is not microprocessor-based, but rather is configured to control operation of propulsion system 200 based on one or more sets of hardwired instructions.

Electric powertrain assembly 200 further includes an operator interface 280 which includes a plurality of input devices 282 and a plurality of output devices 284. Exemplary input devices 282 include levers, buttons, switches, soft keys, touch screens, and other suitable input devices. Exemplary output devices 284 include lights, displays, audio devices, tactile devices, and other suitable output devices. In some examples, operator interface 280 includes a display, such as a touch screen display, and electronic controller 270 interprets various types of touches to the touch screen display as inputs and controls the content displayed on touch screen display. In some examples, input devices 282 includes a mode input. Mode input provides an indication to electronic controller 270 of limits, setups, and other characteristics for electric powertrain assembly 200 of snowmobile 100 and/or other components and systems of snowmobile 100.

In exemplary modes, values for forward movement torque and speed performance, rearward movement torque and speed performance, and regenerative shock and/or braking performance are provided for the various selectable modes. In one exemplary forward mode used for towing, climbing, or getting out of stuck situations, torque is maximized. In another exemplary forward mode, top speed (high endless track speed) is the focus. In a further exemplary forward economy mode, battery range is maximized. In an exemplary reverse mode, torque is maximized, and speed is limited over normal operation. An operator input may be provided, such as a button on the handlebars, to override limited speed. In a first exemplary regeneration mode, a level of regenerative braking in increased for situations like descending a hill. In this regeneration mode, motor 202 provides much of the braking and captures energy for storage in battery assemblies 240 and the physical brakes would be used to supplement the motor regenerative braking. In a second exemplary regeneration mode, motor 202 provides very little freewheeling resistance and slowing snowmobile 100 down would rely solely on the physical brakes on snowmobile 100. In a third exemplary mode, a level of motor 202 regenerative braking is between the first exemplary mode and the second exemplary mode. In a fourth exemplary mode, a level of motor 202 regenerative braking is variable depending on one or more of brake lever position, brake system fluid pressure, and/or endless track speed.

In some examples, driveline 230 includes a peak torque limiter (not shown). The peak torque limiter may be integrated as part of drive shaft 142 of endless track assembly 104, within a chaincase or transmission if included, or mounted directly to the electric motor.

FIGS. 9-11 illustrate an example transmission assembly 900 in accordance with some examples disclosed herein. The example transmission assembly 900 may be used by the example snowmobile 100. Additionally, or alternatively, the example transmission assembly 900 may be used by other snowmobiles, or other vehicles, as may be recognized by those of ordinary skill in the art.

The transmission assembly 900 includes a first gear assembly 904 and a second gear assembly 908. The first gear assembly 904 includes a plurality of sprockets, such as a first sprocket 912 and a second sprocket 916. The first gear assembly 904 further includes a first endless coupler, illustratively belt 920. The second gear assembly 908 includes a plurality of sprockets, such as a third sprocket 924 and a fourth sprocket 928. The second gear assembly 908 further includes a second endless coupler, illustratively belt 932.

The first belt 920 extends around the first sprocket 912 and the second sprocket 916. For example, the first sprocket 912 and the second sprocket 916 may each include a plurality of grooves and the first belt 920 may also include a plurality of grooves. The grooves of the first and second sprockets 912, 916 may engage with the grooves of the first belt 920, such that when the second sprocket 916 is rotated, the first sprocket 912 is also rotated, via the first belt 920, or vice-versa.

Similarly, the second belt 932 extends around the third sprocket 924 and the fourth sprocket 928. The third sprocket 924 and the fourth sprocket 928 may each include a plurality of grooves and the second belt 932 may also include a plurality of grooves. The grooves of the third and fourth sprockets 924, 928 may engage with the grooves of the second belt, such that when the fourth sprocket 928 is rotated, the third sprocket is also rotated, via the second belt 932, or vice-versa.

The transmission assembly 900 further includes an input shaft 936, an output shaft 940, and a selector 944. In some examples, the input shaft 936 of the transmission assembly 900 is coupled to a driven pulley 948 of a continuously variable transmission (“CVT”). The driven pulley 948 is coupled to a drive pulley (not shown) through an endless coupler (not shown). The drive pulley is coupled to electric motor assembly 202, in the illustrated embodiment. However, it is considered that in alternative embodiments, the drive pulley may be coupled to a gas engine (not shown), using configurations that will be recognized by those of ordinary skill in the art. In embodiments, the drive pulley is coupled to the output shaft of the electric motor assembly 202 and drives the rotation of shaft 936 by rotating driven pulley 948. The selector 944 is operatively coupled to the input shaft to engage one of the first gear assembly 904 or the second gear assembly 908. For example, the selector 944 may engage one of the second sprocket 916 (e.g., of the first gear assembly 904) or the fourth sprocket 928 (e.g., of the second gear assembly 908). The input shaft 936 extends through the second sprocket 916, the selector 944, and the fourth sprocket 928, wherein the selector 944 may be disposed between the second sprocket 916 and the fourth sprocket 928. Therefore, the selector 944 may shift, or slide, along the input shaft 936 to engage one of the first gear assembly 904 or the fourth gear assembly.

Selector 944 rotates with input shaft 936 while each of sprocket 916 and sprocket 928 are not directly coupled to input shaft 936. Each of sprocket 916 and sprocket 928 are selectively coupled to input shaft 936 based on the engagement of selector 944 to either of the respective sprocket 916 and sprocket 928. The unengaged one of sprocket 916 and sprocket 928 also rotates when not engaged with selector 944 due to each of sprocket 912 and sprocket 924 being coupled to output shaft 940.

The output shaft 940 extends through the first sprocket 912 and the third sprocket 924. The output shaft 940 may extend through a structural frame 952 of a snowmobile. For example, the structural frame 952 may be similar to the structural frame 110 described earlier herein with respect to the snowmobile 100. The output shaft 940 may be extend into, or otherwise be coupled to, a drive shaft 956. The drive shaft 956 may be coupled to an endless track through drive sprocket 960, the endless track may be similar to the endless track assembly 148 described earlier herein with respect to the example snowmobile 100.

In some examples, the second sprocket 916 and the third sprocket 924 may have the same diameter. Alternatively, in some examples, the second sprocket 916 may be larger in diameter than the third sprocket 924, or vice-versa. Similarly, in some examples, the first sprocket 912 may have the same diameter as the third sprocket 924. Alternatively, in some examples, the third sprocket 924 may be larger in diameter than the third sprocket 924, or vice-versa. Generally, one of the first or second gear assembly 904, 908 may be a high gear assembly, while the other of the first or second gear assembly 904, 908 may be a low gear assembly.

In some examples, a ratio may be determined between the first gear assembly 904 and the second gear assembly 908, based on a diameter of one or more of the first and second sprocket 912, 916 to one or more of the third and fourth sprocket 924, 928. For example, a ratio of the second gear assembly 908 to the first gear assembly 904 may be about 2, and/or greater than 1, and/or less than 5. Additional and/or alternative gear ratios may be recognized by those of ordinary skill in the art, at least in light of teaching described herein and/or routine experimentation that incorporates some aspects described herein.

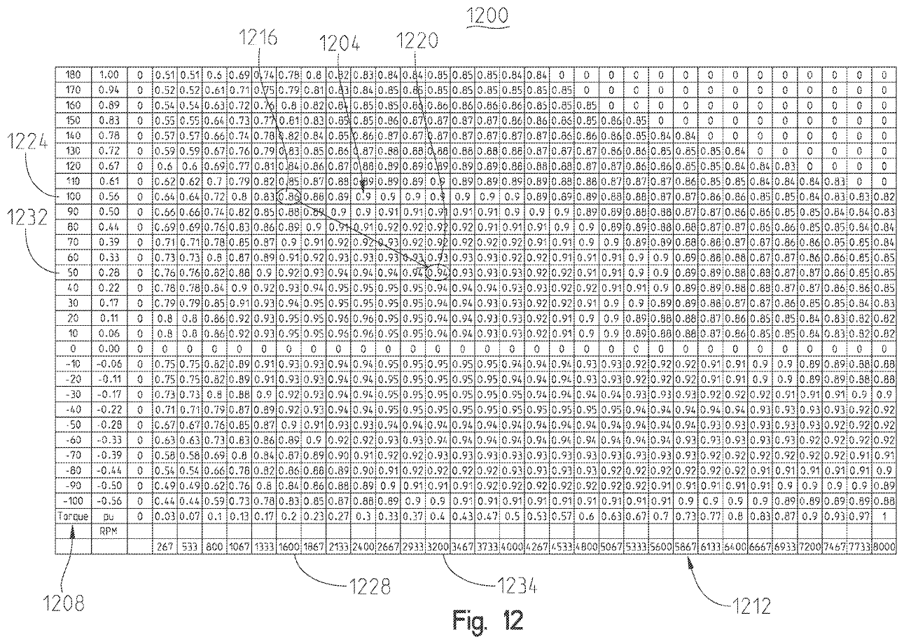

FIG. 12 illustrates an example table 1200 that includes a transmission shift, based on operating points, according to some aspects described herein. In snowmobiles, such as electric snowmobiles, a battery can make up a relatively high percentage of a total weight of the snowmobile. An electric motor (e.g., of electric motor assembly 202) may have an efficiency curve with maximums of about 97% efficiency. When the electric motor runs in areas of relatively low efficiency, the battery of the snowmobile drains relatively quickly. Therefore efficiency curves of the electric motor can be calibrated into a controller (e.g., controller 270), such that a transmission (e.g., transmission 900) can automatically be shifted from a first gear (e.g., first gear assembly 904) to a second gear (e.g., second gear assembly 908) to increase an efficiency of the electric motor. It should be recognized that while the example table 1200 describes a transmission shift for a two gear configuration, mechanisms provided herein may be similarly applied to configurations with greater than two gears, such as three gear configurations, four gear configurations, etc.

Examples disclosed herein may be advantageous for improving electric motor efficiency, as well as battery range. For example, if a motor is running at 90% efficiency, compared to 60% efficiency, at a given point, then the range can be increased by 50%. Additionally, in such an example, 50% less heat needs to be rejected from the snowmobile, that would otherwise be caused by motor inefficiency. Such an advantage would decrease an amount of liquid cooling that may be need and/or allow for a motor and/or battery to be air-cooled, as opposed to liquid cooled. Generally, improving mechanisms for automatically shifting gears, to improve motor efficiency, may decrease cost, size, and/or complexity of systems included within a snowmobile assembly (e.g., snowmobile 100).

Referring specially to FIG. 12, a plurality of operating points 1204 are disclosed. The plurality of operating points 1204 are each based on one of a plurality of torques 1208 (e.g., measured in Nm) and one of a plurality of rotations-per-minute (RPM) 1212 of a motor or engine. Each operating point of the plurality of operating points 1204 includes a motor efficiency. In some examples, each operating point of the plurality of operating points 1204 may instead include an engine efficiency, such as in examples where mechanisms disclosed herein are used in conjunction with a gas-powered vehicle, such as a gas-powered snowmobile.

FIG. 12 illustrates a shift from a first operating point 1216 of the plurality of operating points 1204 to a second operating point 1220 of the plurality of operating points. The first operating point 1216 corresponds to a first motor efficiency (e.g., 86%) and the second operating point 1220 corresponds to a second motor efficiency (e.g., 94%). Further, the first operating point 1216 may be based on a first torque 1224 (e.g., 100 Nm) and a first rpm 1228 (e.g., 1600). The second operating point 1220 may be based on a second torque 1232 (e.g., 50 Nm) and a second rpm 1234 (e.g., 3200). Accordingly, the transmission shift from the first operating point 1216 (e.g., a high gear position) to the second operating point 1220 (e.g., a low gear position) may result in an increase in efficiency, which is advantageous, as discussed earlier herein.

The plurality of operating points 1204 may be stored in a controller (e.g., in memory 274 of controller 270). Accordingly, a controller may compare measured torque values and RPM values to the plurality of torques 1208 and the plurality of RPM 1212 to determine to which of the plurality of operating points 1204 they correspond. A controller may further calculate whether shifting from a first operating point (e.g., first operating point 1216) to a second operating point (e.g., second operating point 1220), based on a transmission gear ratio (e.g., a ratio between the first gear assembly 904 and the second gear assembly 908) would result in an increase in efficiency. If such a shift would increase efficiency, then the controller may send a signal to the transmission (e.g., the selector 944 of the Transmission assembly 900) to engage shift from a first gear assembly (e.g., first gear assembly 904 or second gear assembly) to a second gear assembly (e.g., second gear assembly 908 or first gear assembly 904).

While the shifting in gear assemblies described herein references back to the example transmission assembly 900 of FIGS. 9-11, it should be recognized that similar mechanisms may be applied in other transmission assemblies. For example, mechanisms described herein may be used in conjunction with transmission assemblies that have any number of a plurality of gear assemblies, or any sized gears included within any of the plurality of gear assemblies. In some examples, gear ratios can be configured such that a motor or engine displays a relatively high efficiency (e.g., optimal efficiency) at one or more of the most common operating points of the plurality of operating points 1204.

FIG. 13 illustrate an example method 1300 for auto shifting a transmission, according to some aspects described herein. The example method 1300 may be performed to auto-shift transmissions disclosed herein, such as transmission 900 described with respect to FIGS. 9-11. Additionally, or alternatively, method 1300 may be implemented in conjunction with other transmissions that may be known to those of ordinary skill in the art.

Method 1300 begins at operation 1302, wherein a first indication is received. The first indication may correspond to the torque of a motor (e.g., of electric motor assembly 202). The torque of the motor may be measured from a motor controller (e.g., controller 270), such as in examples where the torque is a configurable input to the motor controller. Additionally, or alternatively, the torque of the motor may be measured via a sensor within a motor assembly (e.g., electric motor assembly 202). Additionally, or alternatively, the torque may be calculated based on measurable inputs to a motor assembly, measurable outputs from a motor assembly, and/or measurements taken, via sensors, within a motor assembly.

Alternatively, in some examples, the first indication may correspond to the torque of an engine (a gas-powered engine, as referenced earlier-herein). Accordingly, the torque of the engine may be measured from a controller, such as in instances where the torque is a configurable input to the controller. Additionally, or alternatively, the torque of the engine may be measure via a sensor within an engine assembly. Additionally, or alternatively, the torque may be calculated based on measurable inputs to an engine assembly, measurable outputs from the engine assembly, and/or measurements taken, via sensors, within an engine assembly. Conventional inputs, outputs, and/or sensors may be recognized by those of ordinary skill in the art.

At operation 1304, a second indication is received. The second indication may correspond to rotations-per-minute (RPM) of the motor. The RPM of the motor may be measured from a motor controller (e.g., controller 270), such as in examples where the RPM is a configurable input to the motor controller. Additionally, or alternatively, the RPM of the motor may be measured, via a sensor, within a motor assembly (e.g., electric motor assembly 202). Additionally, or alternatively, the RPM may be calculated based on measurable inputs to a motor assembly, measurable outputs from a motor assembly, and/or measurements taken, via sensors, within a motor assembly.

The first and second indications may be received at a controller (e.g., controller 270). Additionally, or alternatively, at least one of the first indication and the second indication may be received via a controller area network (CAN). Additionally, or alternatively, the first and/or second indications may be received from a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, a local area network (LAN), a wide area network (WAN), a public network (e.g., the Internet), a private or semi-private network (e.g., a corporate or university intranet), or any other suitable network or combination of networks that are in communication with the controller via wired links, fiber optics links, Wi-Fi links, Bluetooth links, cellular links, etc.

Alternatively, in some examples, the second indication may correspond to RPM of the engine. The RPM of the engine may be measured from a controller, such as in examples where the RPM is a configurable input to the controller. Additionally, or alternatively, the RPM of the engine ma be measured, via a sensor, within an engine assembly. Additionally, or alternatively, the RPM may be calculated based on measurable inputs to an engine assembly, measurable outputs from the engine assembly, and/or measurements taken, via sensors, within an engine assembly. Conventional inputs, outputs, and/or sensors may be recognized by those of ordinary skill in the art.

At operation 1306, an efficiency of the motor is calculated, based on the first indication and the second indication. The efficiency of the motor may be a measure of mechanical power output from the motor, with respect to electric power input to the motor, such as in examples where the motor is included within an electric motor assembly (e.g., electric motor assembly 202). Additional and/or alternative calculations for motor efficiency may be recognized by those of ordinary skill in the art. Further, calculations for engine efficiency may be recognized by those of ordinary skill in the art, in examples where a gas-powered engine is used in conjunction with aspects described herein.

At operation 1308, it is determined if the efficiency of operation 1306 corresponds to a shift from a first gear to a second gear. For example, the efficiency may correspond to a first operating point on a lookup table (e.g., first operating point 1216 or second operating point 1220 of FIG. 12). Based on a preconfigured gear ratio (e.g., of the first gear to the second gear), a second operating point (e.g., second operating point 1220 or first operating point 1216) may be determined. The efficiency of operation 1306 may be a first efficiency and the second operating point may correspond to a second efficiency. If the second efficiency is higher than the first efficiency, then it may be determined that the efficiency of operation 1306 correspond to a shift from the first gear to the second gear. Alternatively, if the second efficiency is lower than the first efficiency, then it may be determined that the efficiency of operation 1306 does not correspond to a shift from the first gear to the second gear.

In some examples, a difference between the first efficiency and the second efficiency may be compared to a predetermined threshold. In such instances, the difference must be greater than the predetermined threshold, to justify shifting from the first gear to the second gear. The predetermined threshold may be configurable, by a manufacturer or a user of a vehicle (e.g., snowmobile).

If it is determined that the efficiency of operation 1306 does not correspond to a shift from a first gear to a second gear, flow branches “NO” to operation 1310, where a default action is performed. For example, the efficiency may have an associated pre-configured action. In other examples, method 1300 may comprise determining whether the efficiency has an associated default action, such that, in some instances, no action may be performed as a result of the calculated efficiency. Method 1300 may terminate at operation 1310. Alternatively, method 1300 may return to operation 1302 to provide an iterative loop of receiving a first indication that corresponds to torque of a motor or engine, receiving a second indication that corresponds to RPM of the motor or engine, calculating an efficiency for the motor or engine, and determining if the efficiency corresponds to a shift from a first gear to a second gear.

If however, it is determined that the efficiency does correspond to a shift from a first gear to a second gear, flow instead branches “YES” to operation 1312, wherein a speed of the a snowmobile (e.g., snowmobile 100) is determined. The speed of the snowmobile may be determined based on inputs to a motor or engine, outputs from the motor or engine, sensors within the motor or engine, and/or gear ratios of a transmission of the snowmobile. For example, the output speed of a motor may be calculated based on an RPM of the motor and a gear ratio of a transmission of the motor.

At operation 1314, it is determined if the speed is less than a predetermined threshold. For example, the predetermined threshold may be a speed of between about 10 miles per hour and about 20 miles per hour. Alternatively, in some examples, the predetermined threshold may be about 15 miles per hour.

If it is determined that the speed is not less than (e.g., greater than) a predetermined threshold, flow branches “NO” to operation 1310, where a default action is performed. For example, the speed may have an associated pre-configured action. In other examples, method 1300 may comprise determining whether the speed has an associated default action, such that, in some instances, no action may be performed as a result of the determined speed. Method 1300 may terminate at operation 1310. Alternatively, method 1300 may return to operation 1302 to provide an iterative loop of receiving first and second indications, calculating an efficiency, determining if the efficiency corresponds to a gear shift, and determining if a speed of a snowmobile is less than a predetermined threshold, for the gear shift to be implemented.

If however, it is determined that the speed is less than the predetermined threshold, flow instead branches “YES” to operation 1316, wherein, based on the calculated efficiency, a shift is automatically performed from the first gear to the second gear.

Method 1300 may terminate at operation 1316. Alternatively, method 1300 may return to operation 1302 (or any other operation from method 1300) to provide an iterative loop, such as of receiving indications corresponding to characteristics of a motor or engine, calculating an efficiency of the motor or engine, and determining whether or not to shift between gears, to improve an efficiency of the motor or engine.

Generally, mechanisms disclosed herein provide for the ability to automatically shift gears to improve motor efficiency, improve battery range, decrease a required amount of liquid cooling, decrease costs, decrease part sizes, and/or otherwise reduce complexity of systems included within a snowmobile assembly (e.g., snowmobile 100). Additionally and/or alternative advantages may be recognized by those of ordinary skill in the art.

FIG. 14 illustrates an example of a battery assembly 1440 operably coupled to the snowmobile 100, according to some aspects described herein. The battery assembly 1440 may be similar to the battery assembly 240, described earlier herein. The battery assembly 1440 may be configured to be coupled to the structural frame 110. For example, the battery assembly 1440 may be removably coupled to the structural frame 110, such as via fasteners, clips, slidable attachment, snappable attachment, etc.

In some examples, as shown in FIG. 14, the battery assembly 1440 may be coupled to the structural frame 110 between the operator seat 132 and the tunnel 116. Alternatively, in some examples, the battery assembly 1440 may be coupled to a right side of the frame 110 or a left side of the frame 110, as discussed with respect to FIG. 5. Alternatively, the battery assembly 1440 may be coupled to any portion of the snowmobile 100 (e.g., the body 103, the frame 110, etc.), as may be recognized by those of ordinary skill in the art. In some examples, the battery assembly 1440 may comprise a plurality of battery assemblies 1440 that are each disposed at the same or different location on the snowmobile 100.

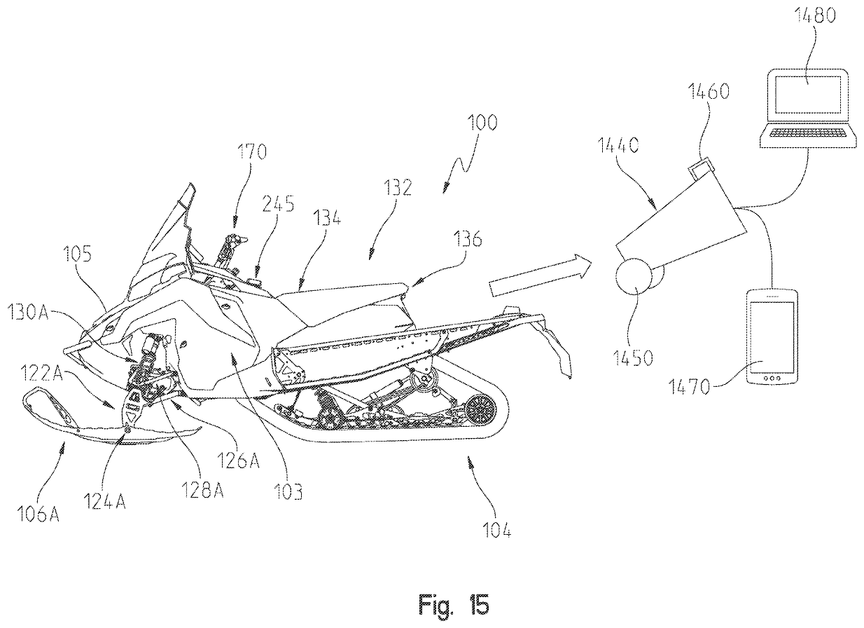

FIG. 15 illustrates an example of the battery assembly 1440 of FIG. 14 de-coupled from the snowmobile 100, according to some aspects described herein. Generally, the battery assembly 1440 is configured to be used as an external generator, when de-coupled from the structural frame 110 and the electric motor assembly 202. The battery assembly 1440 may be decoupled from other structural components, as well, such as the charger 260 and the controller 270, in examples that include such components.

In some examples, the battery assembly 1440 may include one or more wheels 1450. Further, the battery assembly 1440 may include a handle 1460. The handle 1460 may be configured for a user to carry or roll the battery assembly 1440. For example, the battery assembly 1440 may be removed from the snowmobile 100 and a user may roll the battery assembly 1440 to a location that is spaced apart from the snowmobile 100, such that the battery assembly 1440 may be used as a generator for one or more devices, such as a first device 1470 and/or a second device 1480.

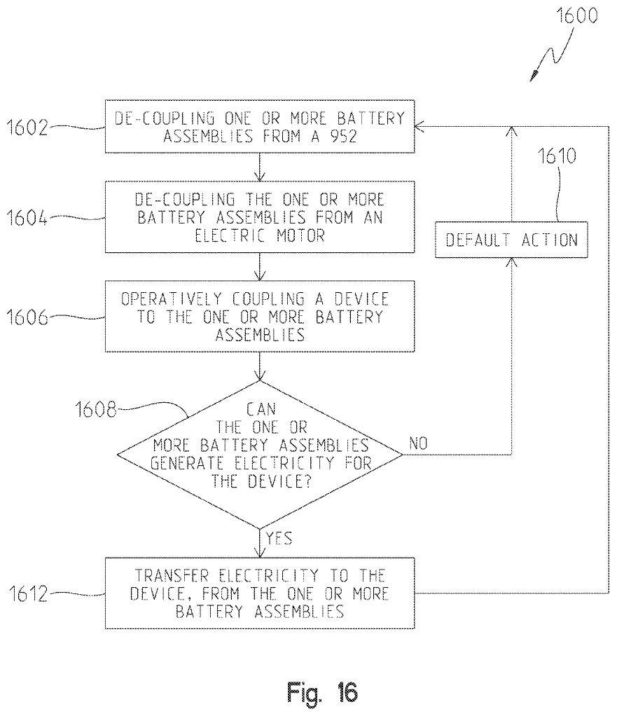

FIG. 16 illustrates an example method 1600 of generating electricity for a device (e.g., first device 1470 and/or second device 1480), using a battery assembly (e.g., battery assembly 1440) from a snowmobile (e.g., snowmobile 100).

At operation 1602, one or more battery assemblies (e.g., battery assembly 1440) are de-coupled from a structural frame (e.g., frame 110 of snowmobile 100). The one or more battery assemblies may be de-coupled from the structural frame by removing fasteners, by untying fastening elements, by unsnapping, rotating, or otherwise decoupling the one or more battery assemblies from the structural frame.

At operation 1604, the one or more battery assemblies are decoupled from an electric motor (e.g., of electric motor assembly 202). The one or more battery assemblies may be decoupled from additional and/or alternative components or systems to which the one or more batteries were initially removably coupled (e.g., controllers, chargers, lights, cooling systems, etc.).

At operation 1606, one or more devices (e.g., first device 1470 and/or second device 1480) are operatively coupled to the one or more battery assemblies. The one or more devices may be electronic devices, such as smartphones, transmitters, gaming systems, computers, televisions, lights, fans, or any other electronic device. The one or more devices may be connected to the one or more battery assembly via wired connections. Additionally, and/or alternatively, the one or more devices may be operatively coupled to the one or more battery assemblies by being placed in contact with an inductive surface of the one or more battery assemblies.

At operation 1608, it is determined if the one or more battery assemblies can generate electricity for the one or more devices. For example, a charge level of the one or more battery assemblies may be determined. If the battery charge level is below a predetermined threshold, then the one or more battery assemblies may be unable to generate electricity for the one or more devices. Conversely, if the battery charge level is above the predetermined threshold, then the one or more battery assemblies may be able to generate electricity for the one or more devices.

Additionally, or alternatively, a charge level of the one or more devices may be determined. If the device charge level is above a predetermined threshold (e.g., fully-charged), then the one or more battery assemblies may be unable to generate electricity for the one or more devices. Conversely, if the device charge level is below the predetermined threshold (e.g., not fully-charged), then the one or more battery assemblies may be able to generate electricity for the one or more devices.

Additionally, or alternatively, the one or more batteries may be required to receive user-input to generate electricity for a device. Therefore, if the one or more batteries have not received user-input indicative of being able to generate electricity for one or more devices, then the one or more batteries may be unable to generate electricity for the one or more devices. For example, a user may press a button, or turn a lever, or speak a command, or provide another form of user-input, which corresponds to enabling the one or more battery assemblies to generate electricity for the one or more devices.

If it is determined that the one or more battery assemblies cannot generate electricity for the one or more device, flow branches “NO” to operation 1610, where a default action is performed. For example, the one or more battery assemblies may have an associated pre-configured action. In other examples, method 1600 may comprise determining whether the one or more battery assemblies have an associated default action, such that, in some instances, no action may be performed as a result of the operative coupling to the one or more devices. Method 1600 may terminate at operation 1610. Alternatively, method 1600 may return to operation 1602 to provide an iterative loop of decoupling one or more battery assemblies to use as an auxiliary generator, removed from a snowmobile, and determining if the one or more battery assemblies can generate electricity for one or more devices.

If however, it is determined that the one or more battery assemblies can generate electricity for the one or more devices, flow instead branches “YES” to operation 1612, wherein, electricity is transferred to the device, from the one or more battery assemblies. The electricity may be transferred via a wired connection. Alternatively, the electricity may be transferred via induction.

In some examples, method 1600 may include swapping the decoupled battery (e.g., from operation 1602 and 1604) with a second battery. In such examples, method 1600 may be a method for swapping batteries. For example, the decoupled battery may be a first traction battery. Generally, a traction battery is a high voltage battery that provides energy for vehicle motion (e.g., snowmobile motion). Vehicles, especially snowmobiles, have a limited distance to travel before their traction battery is out of charge. When the traction battery is out of charge it takes time to recharge the battery. If the traction battery could be removed and replaced with a second traction battery that was charged outside of the vehicle, vehicle uptime would be advantageously increased.

Accordingly, in some examples, after the first battery (e.g., traction battery) is decoupled from the structural frame at operation 1602 and decoupled from the electric motor at operation 1604, a second battery (e.g., traction battery) may be coupled to the electric assembly and/or coupled to the structural frame, such that vehicle uptime is increased.

In some examples, a charge level of the first battery may be analyzed such that when the charge level of the first battery is determined to be below a predetermined threshold, an indication may be provided to a user that is indicative of the charge level being below the predetermined threshold. The indication may be an audio and/or visual indication, such as, for example, a beep, a ring, a voice instruction, a light flash, an icon on a graphical user-interface (GUI), or any other audio and/or visual indication that may be recognized by those of ordinary skill in the art.

In response to providing the indication, a second battery may be received. For example, a user and/or a service provider may replace the first battery with the second battery assembly. A charge level of the second battery may be analyzed, and, in some examples, the second battery may replace the first battery, in response to determining that the charge level of the second battery is higher than the charge level of the first battery (e.g., to increase vehicle uptime). Each of the first and second batteries may be battery assemblies that include respective traction batteries.

Prior to the second battery assembly being received, and in response to providing the indication, the first battery assembly may be de-coupled form the electric motor and/or the structural frame. Subsequently, the second battery assembly may be operatively and removably coupled to the electric motor and/or removably coupled to the structural frame. The second battery assembly may be coupled to the electric motor and/or the structural frame in a similar manner as described earlier herein with respect to the first battery assembly.

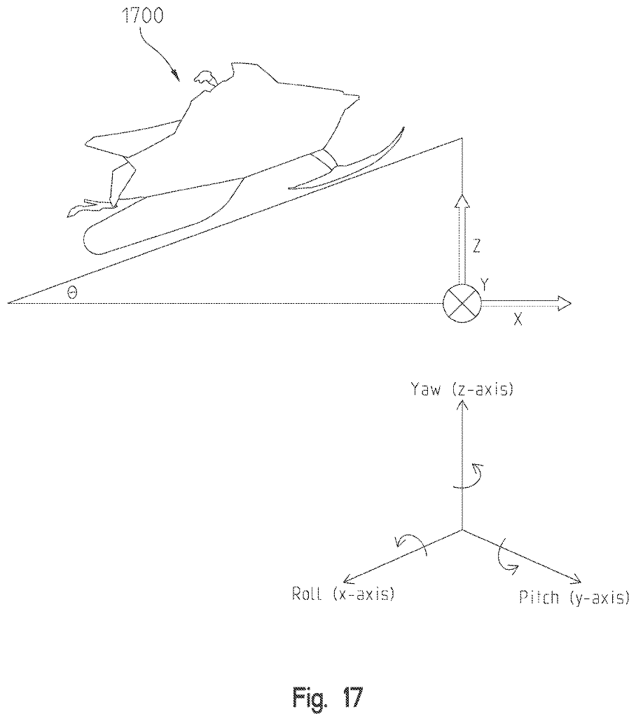

FIG. 17 illustrates an example snowmobile 1700. The snowmobile 1700 may be similar to the snowmobile 100 described earlier herein. The example snowmobile 1700 is on an incline of angle @. As illustrated in FIG. 17, the snowmobile 1700 has a yaw direction (e.g., defined along a z-axis), a pitch direction, (e.g., defined along a y-axis), and a roll direction (e.g., defined along an x-axis). Generally, when the snowmobile 1700 is in use, it may be configured, by a user, to operate along one or more of the yaw direction, pitch direction, or roll direction.

Regenerative braking, as discussed herein, may refer to neutral throttle regeneration torque (e.g., when no brake and no throttle is applied to a snowmobile, such as snowmobile 1700). Additionally, regenerative braking may refer to brake regenerative torque (e.g., when brakes are applied to a snowmobile, such as snowmobile 1700). Pitch, yaw, and roll monitoring devices can be used to identify the angle at which a vehicle (e.g., snowmobile 1700) is operating. The pitch, yaw, and roll parameters can be used as inputs to a controller (e.g., controller 248) to implement changes, automatically, in real-time, to a regenerative breaking profile of a drive mode of the vehicle (e.g., snowmobile 1700).

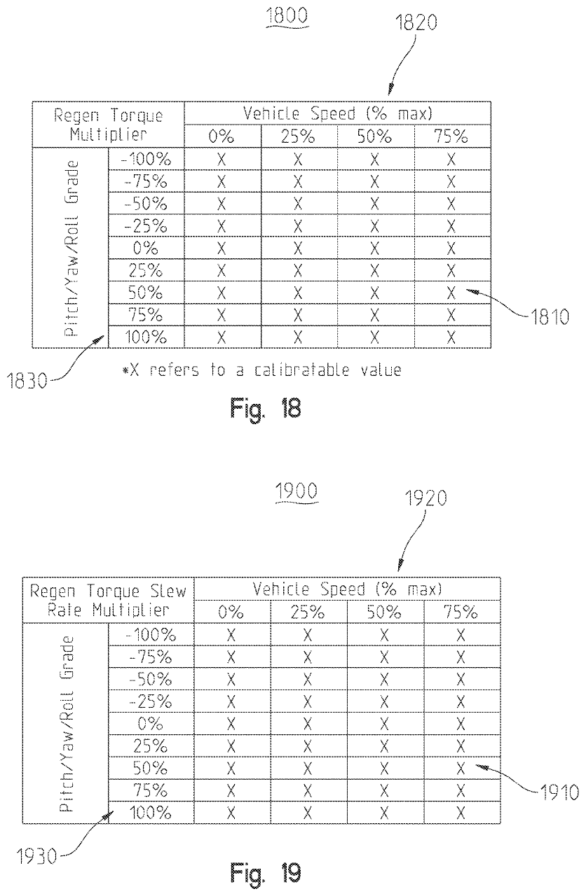

FIG. 18 illustrates an example plot 1800 of a plurality of regenerative torque multipliers 1810, based on one or more vehicle speeds 1820 (e.g., speeds of a snowmobile, such as snowmobile 100 and/or snowmobile 1700), as well as one or more pitch, yaw, or roll grades 1830. Each of the plurality of regenerative torque multipliers 1830 may be a predetermined calibratable value (e.g., real number) that is labelled with “X” in the illustrated example plot, for illustrative purposes. Further, while specific examples of pitch, yaw, and roll grades 1830 are provided in FIG. 18, it should be recognized by those of ordinary skill in the art that mechanisms described herein may be implemented with any grade of pitch, yaw, and/or roll. Additionally, while specific examples of vehicle speeds 1820 are provided in FIG. 18, it should be recognized by those of ordinary skill in the art that mechanisms described herein may be implemented with any vehicle speed.

FIG. 19 illustrates an example plot 1900 of a plurality of regenerative torque slew rate multipliers, based on one or more vehicle speeds 1920 (e.g., speeds of a snowmobile, such as snowmobile 100 and/or snowmobile 1700), as well as one or more pitch, yaw, or roll grades 1930. Each of the plurality of regenerative torque slew rate multipliers 1910 may be a predetermined calibratable value (e.g., real number) that is labelled with “X” in the illustrated example plot, for illustrative purposes. Further, while specific examples of pitch, yaw, and roll grades 1930 are provided in FIG. 19, it should be recognized by those of ordinary skill in the art that mechanisms described herein may be implemented with any grade of pitch, yaw, and/or roll. Additionally, while specific examples of vehicle speeds 1920 are provided in FIG. 19, it should be recognized by those of ordinary skill in the art that mechanisms described herein may be implemented with any vehicle speed.

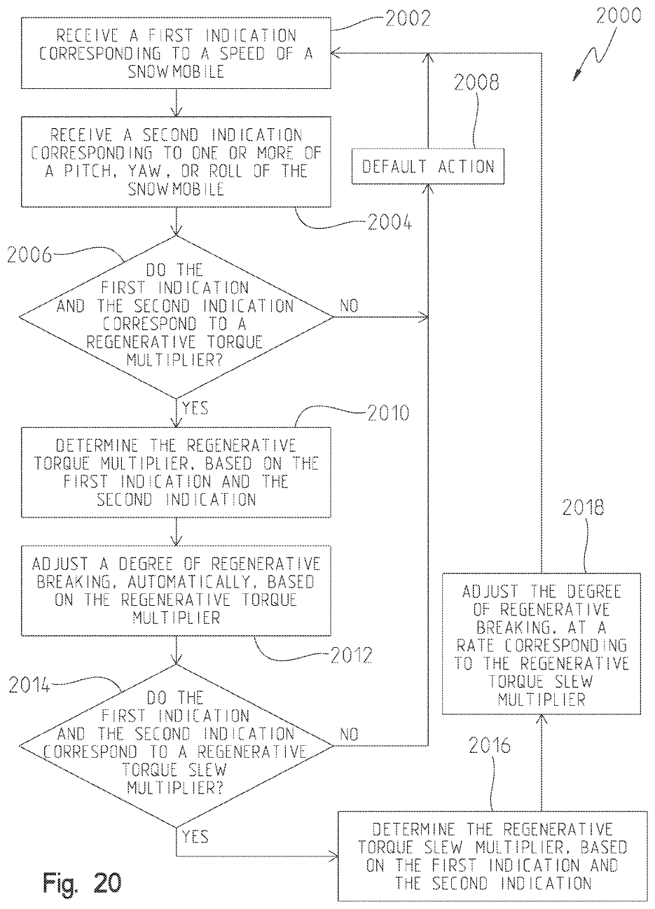

FIG. 20 illustrates an example method 2000 of adjusting regenerative breaking for a snowmobile, according to some aspects described herein. The example method 2000 may be implemented using systems described earlier herein, such as with respect to snowmobile 1700 and/or snowmobile 100. Alternatively, the example method 2000 may be implemented using other systems that may be known to those of ordinary skill in the art.

Method 2000 begins at operation 2002 wherein a first indication is received. The first indication corresponds to a speed of a snowmobile (e.g., measured in miles-per-hour). The speed of the snowmobile may be input to, output from, or otherwise measured based on, a motor or engine of a snowmobile (e.g., snowmobile 1700 or snowmobile 100). In some examples, the first indication may include information regarding whether the speed of the snowmobile is increasing or decreasing. For example, the speed of the snowmobile may be measured, over a duration of time, such that the first indication further corresponds to an increase or a decrease in the speed of the snowmobile.

At operation 2004 a second indication is received. The second indication corresponds to one or more of a pitch, yaw, or roll of the snowmobile. Accordingly, in some examples, the second indication may correspond to a pitch of a snowmobile, or a yaw of a snowmobile, or a roll of a snowmobile. The pitch, yaw, and roll may be measured along the pitch-direction, the yaw-direction, and the roll-direction, respectively, described earlier herein, with respect to FIG. 17.

In some examples, the second indication may include information regarding whether a pitch of the snowmobile is increasing or decreasing. For example, the pitch of the snowmobile may be measured, over a duration of time, such that the second indication further corresponds to an increase or a decrease in the pitch of the snowmobile. Similarly, the second indication may include information regarding whether a yaw and/or a roll of the snowmobile is increasing or decreasing. For example, the yaw and/or the roll may be measured, over a duration of time, such that the second indication further corresponds to an increase or decrease in the yaw and/or roll of the snowmobile.

The first indication of operation 2002 and/or the second indication of operation 2004 may be received by a controller (e.g., controller 248). Further, the first indication and/or the second indication may be received from an inertial measurement unit (IMU), in real time. The inertial measurement unit may be coupled to the controller to provide information such as acceleration, speed, angular rate of change, angular orientation, etc.

At operation 2006 it may be determined if the first indication and the second indication correspond to a regenerative torque multiplier. For example, a user or manufacturer may preconfigure, for the snowmobile, a plurality of regenerative torque multiplier values (e.g., the plurality of generative torque multiplier values 1810 of FIG. 18). The plurality of regenerative torque multiplier values may be stored (e.g., in memory 274 of the controller 248), such that, a processor (e.g., processor 272) may determine if the first and second indications correspond to a respective regenerative torque multiplier.

If it is determined that the first and second indications do not correspond to a regenerative torque multiplier (e.g., a regenerative torque multiplier is not defined for the speed of the snowmobile and/or the pitch, yaw, or roll of the snowmobile), flow branches “NO” to operation 2008, where a default action is performed. For example, the first indication and/or the second indication may have an associated pre-configured action. In other examples, method 2000 may comprise determining whether the first indication and/or the second indication have an associated default action, such that, in some instances, no action may be performed. Method 2000 may terminate at operation 2008. Alternatively, method 2000 may return to operation 2002 to provide an iterative loop of receiving first and second indications, and determining if the first and second indications correspond to a regenerative torque multiplier.

If however, it is determined that the first and second indications do correspond to a regenerative torque multiplier, flow instead branches “YES” to operation 2010, wherein, the regenerative torque multiplier is determined, based on the first indication and the second indication. For example, a processor (e.g., processor 272) may extract, from memory (e.g., memory 274), a regenerative torque multiplier that corresponds to the first indication and the second indication.

Flow advances to operation 2012, wherein a degree of regenerative breaking is adjusted, automatically, based on the determined regenerative torque multiplier. For example, the degree of regenerative breaking may be increase (e.g., made stronger) or decreased (e.g., made weaker). In some examples, if a pitch of a snowmobile increases, and a speed of the snowmobile decrease, then the degree of regenerative breaking may increase. Such an example may occur when a user is driving a snowmobile up an incline (e.g., a hill), and let's go of the throttle (e.g., decreases an amount of throttle).

Conversely, as another example, if a pitch of a snowmobile decreases, and a speed of the snowmobile increases, then the degree of regenerative breaking may decreases. Such an example may occur when a user is driving from a hill to a flat piece of ground and regenerative breaking is not desired. Generally, regenerative breaking may be desired to counteract the force of gravity applied to the snowmobile.

At operation 2014 it may be determined if the first indication and the second indication correspond to a regenerative torque slew multiplier. For example, a user or manufacturer may preconfigure, for the snowmobile, a plurality of regenerative torque slew multiplier values (e.g., the plurality of generative slew torque multiplier values 1910 of FIG. 19). The plurality of regenerative torque slew multiplier values may be stored (e.g., in memory 274 of the controller 248), such that, a processor (e.g., processor 272) may determine if the first and second indications correspond to a respective regenerative torque slew multiplier.

If it is determined that the first and second indications do not correspond to a regenerative torque slew multiplier (e.g., a regenerative torque slew multiplier is not defined for the speed of the snowmobile and/or the pitch, yaw, or roll of the snowmobile), flow branches “NO” to operation 2008, where a default action is performed. For example, the first indication and/or the second indication may have an associated pre-configured action. In other examples, method 2000 may comprise determining whether the first indication and/or the second indication have an associated default action, such that, in some instances, no action may be performed. Method 2000 may terminate at operation 2008. Alternatively, method 2000 may return to operation 2002 to provide an iterative loop of receiving first and second indications, and determining if the first and second indications correspond to a regenerative torque slew multiplier.

If however, it is determined that the first and second indications do correspond to a regenerative torque slew multiplier, flow instead branches “YES” to operation 2016, wherein, the regenerative torque slew multiplier is determined, based on the first indication and the second indication. For example, a processor (e.g., processor 272) may extract, from memory (e.g., memory 274), a regenerative torque slew multiplier that corresponds to the first indication and the second indication.

In some examples, operation 2010 may advance directly to operation 2018, such as in instances where a default regenerative torque slew multiplier is defined. Additionally, or alternatively, in some examples, operation 2004 may advance directly to operation 2014, such as in instances where a default regenerative torque multiplier is defined. Additional and/or alternative operations that may be used in conjunction with aspects of method 2000 may be recognized by those of ordinary skill in the art.

At operation 2018, the degree of regenerative breaking is adjusted, at a rate corresponding to the regenerative torque slew multiplier. Generally, in some examples it may be desired for the onset of a regenerative torque multiplier to be relatively slow, whereas in other examples it may be desired for the onset of a regenerative torque multiplier to be relatively fast. For example, while operating a snowmobile at a relative steep incline, a relatively slow onset of regenerative breaking may be preferred. In contrast, while operating the snowmobile at a relatively steep decline, a relatively fast onset of regenerative breaking may be preferred to control a descent of the snowmobile. Therefore, the regenerative torque slew multiplier provides a time dependency which can slowly or quickly adjust a degree of regenerative breaking.

Method 2000 may terminate at operation 2018. Alternatively, method 2000 may return to operation 2002, from operation 2018, to provide an iterative loop of receiving first and second indications and adjusting a degree of regenerative breaking of a snowmobile, at a rate corresponding to a regenerative torque slew multiplier.

Advantageously, mechanisms disclosed herein provide automated, enhanced control of a snowmobile to improve a user's experience across any of a plurality of different environments. Instead of manually selecting strengths of regenerative breaking, strengths (e.g., a degree) of regenerative breaking can be automatically determined, and applied, in real-time, as a user is operating a snowmobile. Accordingly, user's will not have to make frequent adjustments to regenerative breaking profiles, while driving in locations with frequent changes between inclines, declines, and flat ground, as may otherwise be required with manual implementations.

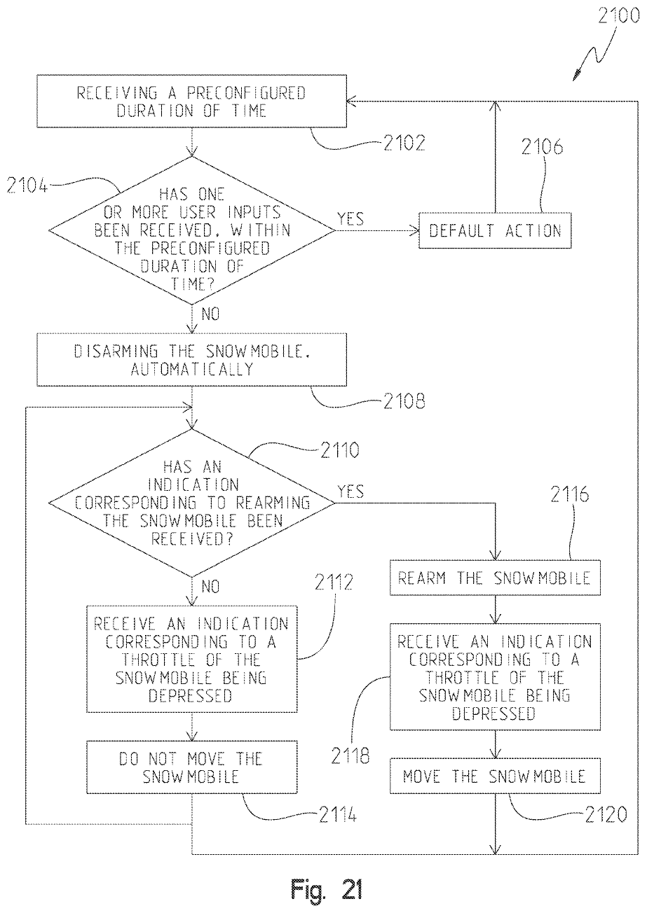

FIG. 21 illustrates an example method 2100 of disarming a snowmobile. In some examples, the method 2100 may be implemented using one or more aspects of systems described earlier herein, such as with respect to snowmobile 100. Additionally, or alternatively, aspects of method 2100 may be implemented using other systems that may be recognized by those of ordinary skill in the art.

Method 2100 beings at operation 2102, wherein a preconfigured duration of time is received. In some examples, the preconfigured duration of time may be set by a user or manufacturer. For example, the preconfigured duration of time may be stored in memory, such as memory of a controller (e.g., controller 248) or of another computing device. The preconfigured duration of time may be a duration of about 5 minutes, or about 15 minutes, or about half an hour, or any other non-zero duration of time.

At operation 2104, it is determined if one or more user-input have been received within the preconfigured duration of time. For example, a controller (e.g., controller 248) may store in memory a timestamp of when one or more user-inputs are received from each of a one or more components. The timestamp of a most recent user-input, of the one or more user inputs, from each of the one or more components, may be compared to the preconfigured duration of time. If a difference between a current time and the timestamp of the most recent user-input, from any of the one or more components, is greater than the preconfigured duration of time, then it may be determined that one or more types of user-input have not been received, for the preconfigured duration of time. In some examples, the user-input comprises one or more of pressing a button or turning a lever. Further, pressing the button or turning the lever may correspond to an increase in throttle.

If it is determined that the one or more user inputs have been received, within the preconfigured duration of time, flow branches “YES” to operation 2106, where a default action is performed. For example, the one or more user inputs may have an associated pre-configured action. In other examples, method 2100 may comprise determining whether the one or more user inputs have an associated default action, such that, in some instances, no action may be performed. Method 2100 may terminate at operation 2106. Alternatively, method 2100 may return to operation 2102 to provide an iterative loop of receiving a preconfigured duration of time and determining if one or more user inputs have been received, within the preconfigured duration of time.

If however, it is determined that one or more user inputs have not been received, within the preconfigured duration of time, flow instead branches “NO” to operation 2108, wherein a snowmobile is automatically disarmed. Disarming the snowmobile may comprise blocking a signal from being sent, via a controller to an electric motor, to throttle the electric motor. For example, a controller (e.g., controller 248) may be programmed or otherwise configured to throttle an electric motor (e.g., electric motor assembly 202). However, by executing one or more instructions, stored in memory of the controller, the controller may be programmed or otherwise configured to not throttle an electric motor, such as when the snowmobile is in a disarmed state (e.g., based on memory of the controller being updated to reflect the execution of operation 2108).

At operation 2110, it is determined if an indication corresponding to rearming the snowmobile has been received. In some examples, the indication may be received from a sensor of a switch, such as a key switch. In examples that include an electric snowmobile, a key switch may not be necessary to ignite an engine, because there may be no engine. However, a sensor within the key switch may provide a signal to a controller corresponding to one of a plurality of key positions, such as a stop position, start position, or a momentary start position. The indication corresponding to rearming the snowmobile may be received from the sensor of the key switch, based on one or more of the plurality of key positions.

Additionally, or alternatively, in some examples, the indication corresponding to rearming the snowmobile may be received from a press of a button, such as an engine start/stop button. In examples that include an electric snowmobile, an engine start/stop button may not be necessary to ignite an engine, because there may be no engine. However, a sensor corresponding to the engine start/stop button may provide a signal to a controller corresponding to one of a plurality of states of the button (e.g., a start state and a stop state). The indication corresponding to rearming the snowmobile may be received from the sensor corresponding to the engine start/stop button, based on a change of state of the engine start/stop button.

Additionally, or alternatively, in some examples, the indication corresponding to rearming the snowmobile may be received from a weight sensor. The weight sensor may correspond to an operator seat of a snowmobile (e.g., operator seat 132). Therefore, in some examples, if an operator sits on the operator seat, an indication corresponding to rearming the snowmobile may be received, thereby rearming the snowmobile.

If it is determined that an indication corresponding to rearming the snowmobile has not been received, flow branches “NO” to operation 2112. At operation 2112 an indication corresponding to a throttle of the snowmobile being depressed is received. The indication corresponding to the throttle being depressed may be generated based on a user adjusting a button or lever of the snowmobile.

At operation 2114 the snowmobile does not move. For example, the snowmobile does not accelerate, despite an indication being received that corresponds to a throttle being depressed, because the snowmobile is disarmed. In an electric snowmobile, there is may be no audible noise from an engine to signal to a user that the snowmobile is live and/or ready to be used. If someone unknowingly walks up to the snowmobile, and presses the throttle lever the snowmobile may move without the user knowing, if it is not disarmed. To resolve this deficiency, the snowmobile is automatically disarmed at operation 2108, such that if the throttle lever is pressed (e.g., at operation 2112), then at operation 2114, the snowmobile does not move.

Method 2100 may terminate at operation 2114. Additionally, or alternatively, from operation 2114, method 2100 may return to operation 2102 (or any other operation of method 2100) to provide an iterative loop of disarming and not moving a snowmobile.

Returning to operation 2110, if it is determined that an indication corresponding to rearming the snowmobile has been received, then flow instead branches “YES” to operation 2216, wherein the snowmobile is rearmed. As discussed above, the snowmobile may be rearmed upon receiving any one of a plurality of indications. In some examples the plurality of indications may correspond to pressing a button, such as an engine stop/start button, turning a switch, such as a key switch with a plurality of positions, triggering a sensor, such as a weight sensor, and/or any other sensors or inputs that may be received and configured to indicate rearming a snowmobile, as may be recognized by those of ordinary skill in the art.

At operation 2118 an indication corresponding to a throttle of the snowmobile being depressed is received. The indication corresponding to the throttle being depressed may be generated based on a user adjusting a button or lever of the snowmobile.

At operation 2120, the snowmobile moves. For example, the snowmobile may accelerate, because the snowmobile has been rearmed. At operation 2120 method 2100 may terminate. Additionally, or alternatively, from operation 2120 method 2100 may return to operation 2102 to provide an iterative loop of disarming and rearming a snowmobile.

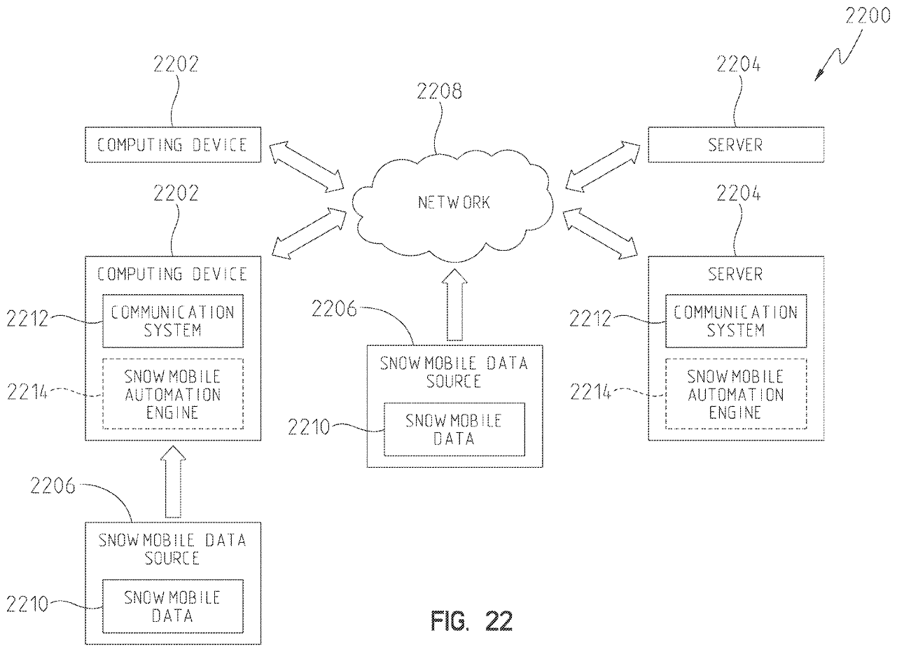

FIG. 22 illustrates a system 2200 in accordance with some examples provided herein. Generally, mechanisms provided herein provide the ability to automate aspects of snowmobile controls to improve an experience for an operator of the snowmobile. While snowmobile examples provided earlier herein (e.g., snowmobile 100 and snowmobile 1700) discuss performing one or more methods/processes via computational components that are local to the snowmobile (e.g., controller 248), it should be recognized that one or more methods/processes, or portions thereof, provided herein (e.g., 1300, 2000, and/or 2100) may be performed local to, and/or remote from, the snowmobile.

The system 2200 includes one or more computing devices 102, one or more servers 2204, a snowmobile data source 2206, and a communication network or network 2208. The computing device 2202 can receive snowmobile data 2210 from the snowmobile data source 2206, which may be, for example one or more sensors that may be found on a snowmobile and/or memory with data stored therein corresponding to snowmobile data. The snowmobile data 2214 may include data corresponding to inputs to an engine or motor assembly of a snowmobile, outputs from an engine or motor assembly of the snowmobile, and/or measurements taken, via sensors, within an engine or motor assembly of the snowmobile.

Additionally, or alternatively, the network 2208 can receive snowmobile data 2210 from the snowmobile data source 2206, which may be, for example one or more sensors that may be found on a snowmobile and/or memory with data stored therein corresponding to snowmobile data. The snowmobile data 2214 may include data corresponding to inputs to an engine or motor assembly, outputs from an engine or motor assembly, and/or measurements taken, via sensors, within an engine or motor assembly.

Computing device 2202 may include a communication system 2212 and a snowmobile automation engine or component 2214. In some examples, computing device 2202 can execute at least a portion of the snowmobile automation component 2214 to automatically shift between gear assemblies, to improve efficiency of a motor or engine assembly, adjust a degree of regenerative breaking, adjust a rate of change of regenerative breaking, automatically disarm a snowmobile, and/or automatically rearm a snowmobile.

Server 2204 may include a communication system 2212 and a snowmobile automation engine or component 2214. In some examples, computing device 2202 can execute at least a portion of the snowmobile automation component 2214 to automatically shift between gear assemblies, to improve efficiency of a motor or engine assembly, adjust a degree of regenerative breaking, adjust a rate of change of regenerative breaking, automatically disarm a snowmobile, and/or automatically rearm a snowmobile.

Additionally, or alternatively, in some examples, computing device 2202 can communicate data received from snowmobile data source 2206 to the server 2204 over the communication network 2208, which can execute at least a portion of the snowmobile automation component 2214. In some examples, snowmobile automation component 2214 may execute one or more portions of methods/processes 1300, 2000, and/or 2100 described above in connection with FIGS. 13, 20, and 21, respectively.

In some examples, computing device 2202 and/or server 2204 can be any suitable computing device or combination of devices, such as a desktop computer, a vehicle computer, a controller, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing device 2202 and/or a plurality of servers 2204.

In some examples, communication network 2208 can be any suitable communication network or combination of communication networks. For example, communication network 110 can include a controller area network (CAN), a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 110 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 22 can each be any suitable communications link or combination of communication links, such as wired links, fiber optics links, Wi-Fi links, Bluetooth links, cellular links, etc. Exemplary vehicle communication systems and associated processing sequences are disclosed in U.S. patent application Ser. No. 16/234,162, filed Dec. 27, 2018, titled RECREATIONAL VEHICLE INTERACTIVE TELEMETRY, MAPPING AND TRIP PLANNING SYSTEM, docket PLR-15-25635.04P-02-US; U.S. patent application Ser. No. 15/262,113, filed Sep. 12, 2016, titled VEHICLE TO VEHICLE COMMUNICATIONS DEVICE AND METHODS FOR RECREATIONAL VEHICLES, docket PLR-09-27870.01P-US; U.S. Pat. No. 10,764,729, titled COMMUNICATION SYSTEM USING VEHICLE TO VEHICLE RADIO AS AN ALTERNATE COMMUNICATION MEANS, filed Dec. 12, 2018; US Published Patent Application No. US20190200189, titled COMMUNICATION SYSTEM USING CELLULAR SYSTEM AS AN ALTERNATE TO A VEHICLE TO VEHICLE RADIO, filed Dec. 12, 2018; US Published Patent Application No. US20190200173, titled METHOD AND SYSTEM FOR FORMING A DISTANCED-BASED GROUP IN A VEHICLE TO VEHICLE COMMUNICATION SYSTEM, filed Dec. 12, 2018; US Published Patent Application No. US20190200188, titled VEHICLE-TO-VEHICLE COMMUNICATION SYSTEM, filed Dec. 12, 2018; U.S. patent application Ser. No. 16/811,865, filed Mar. 6, 2020, titled RECREATIONAL VEHICLE GROUP MANAGEMENT SYSTEM, docket PLR-15-27455.02P-03-US; U.S. Patent Application Ser. No. 63/016,684, filed Apr. 28, 2020, titled SYSTEM AND METHOD FOR DYNAMIC ROUTING, docket PLR-00TC-27721.01P-US; U.S. patent application Ser. No. 16/013,210, filed Jun. 20, 2018, titled VEHICLE HAVING SUSPENSION WITH CONTINUOUS DAMPING CONTROL, docket PLR-15-25091.04P-03-US; and U.S. patent application Ser. No. 15/816,368, filed Nov. 17, 2017, titled VEHICLE HAVING ADJUSTABLE SUSPENSION, docket PLR-15-25091.08P-US, the entire disclosures of which are expressly incorporated by reference herein.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of auto-shifting a snowmobile transmission, the method comprising:
receiving a first indication, the first indication corresponding to torque of a motor;
receiving a second indication, the second indication corresponding to rotations per minute (RPM) of the motor;
calculating an efficiency of the motor, based on the first indication and the second indication; and
shifting, automatically, from a first gear to a second gear, based on the calculated efficiency.

2. The method of claim 1, further comprising, prior to shifting from the first gear to the second gear, determining that a speed of the snowmobile is less than a predetermined threshold.

3. The method of claim 2, wherein the predetermined threshold is between about 10 miles-per-hour and about 20 miles-per-hour.

4. The method of claim 1, wherein the first and second indications are received at a controller, and wherein at least one of the first indication or the second indication are received via a controller area network (CAN).

5. The method of claim 1, wherein shifting from the first gear to the second gear is configured to increase an efficiency of the motor.

6. The method of claim 5, wherein the first gear comprises a high gear assembly, and wherein the second gear comprises a low gear assembly.

7. The method of claim 6, wherein the high and low gear assemblies each comprise a respective belt and plurality of sprockets.

8. A snowmobile comprising:
a plurality of ground engaging members comprising an endless track and a plurality of front skis;
a structural frame supported by the plurality of ground engaging members; and
an electric powertrain operatively coupled to the endless track to power movement of the endless track, the electric powertrain comprising a controller, the controller comprising one or more processors and memory storing instructions that when executed, by the one or more processors, cause the controller to execute a set of operations, the set of operations comprising the method of claim 1.

9. A snowmobile comprising:
a plurality of ground engaging members comprising an endless track and a plurality of front skis;
a structural frame supported by the plurality of ground engaging members; and
a powertrain operatively coupled to the endless track to power movement of the endless track, the powertrain comprising an engine having an exhaust system, an intake system, a drive system comprising a continuously variable transmission (CVT), and a controller, the controller comprising one or more processors and memory storing instructions that when executed, by the one or more processors, cause the controller to execute a set of operations, the set of operations comprising the method of claim 1.

10. A snowmobile transmission assembly comprising:
an input shaft;
an output shaft;
a first gear assembly, the first gear assembly including a first sprocket, a second sprocket, and a first belt extending around the first sprocket and the second sprocket; and
a second gear assembly, the second gear assembly including a third sprocket, a fourth sprocket, and a second belt extending around the third sprocket and the fourth sprocket; and
a selector operatively coupled to the input shaft to engage one of the first gear assembly or the second gear assembly, via one of the second sprocket, or the fourth sprocket,
wherein the input shaft extends through the second sprocket, the selector, and the fourth sprocket, and
wherein the output shaft extends through the first sprocket and the third sprocket.

11. The snowmobile transmission assembly of claim 10, wherein the output shaft is configured to rotate a drive shaft, the drive shaft being coupled to an endless track assembly.

12. The snowmobile transmission assembly of claim 10, wherein the input shaft is coupled to a torque converter.

13. The snowmobile transmission assembly of claim 10, wherein a ratio of the second gear assembly to the first gear assembly is greater than 1 and less than 5.

14. The snowmobile transmission assembly of claim 10, wherein a rotation of the input shaft is configured to rotate the drive shaft, via one of the first belt or the second belt.

15. The snowmobile transmission assembly of claim 10, wherein the selector is configured to automatically engage the first gear assembly or the second gear assembly, based on input received from a controller.

16. A snowmobile comprising:
a plurality of ground engaging members including an endless track positioned along a vertical centerline plane of the snowmobile, a left front ski, and a right front ski, the endless track being positioned rearward of the left front ski and the right front ski;
a structural frame supported by the plurality of ground engaging members, the structural frame provides structural rigidity for the snowmobile, the structural frame including a tunnel:
an electric powertrain operatively coupled to the endless track to power movement of the endless track, the electric powertrain comprising an electric motor operatively coupled to the endless track; and
one or more battery assemblies operatively and removably coupled to the electric motor, the one or more battery assemblies being removably coupled to the structural frame, the one or more battery assemblies being configured for use as an external generator, when de-coupled from the structural frame and the electric motor.

17. The snowmobile of claim 16, wherein the one or more battery assemblies each comprise a rechargeable battery, a high voltage box, and a standard voltage box. 18. The snowmobile of claim 16, wherein the one or more battery assemblies each comprise one or more wheels.

19. The snowmobile of claim 16, further comprising:
an operator seat, the operator seat being supported by the structural frame,
wherein the one or more battery assemblies are configured to be coupled to the structural frame, between the tunnel and the operator seat.

20. The snowmobile of claim 16, wherein the one or more battery assemblies each include a handle, the handle being configured for a user to carry or roll each of the one or more battery assemblies.

21. A method of generating electricity for a device, using the snowmobile of claim 16, the method comprising:
de-coupling the one or more battery assemblies from the structural frame;
de-coupling the one or more battery assemblies from the electric motor;
operatively coupling the device to the one or more battery assemblies; and
transferring electricity to the device, from the one or more battery assemblies.

22. A method of adjusting regenerative breaking for a snowmobile, the method comprising:
receiving a first indication, the first indication corresponding to a speed of the snowmobile;
receiving a second indication, the second indication corresponding to one or more of a pitch, yaw, or roll of the snowmobile;
determining a regenerative torque multiplier, based on the first indication and the second indication; and
adjusting a degree of regenerative breaking, automatically, based on the regenerative torque multiplier.

23. The method of claim 22, wherein the second indication corresponds to vehicle pitch.

24. The method of claim 22, wherein the second indication corresponds to an increased pitch of the snowmobile, wherein the first indication corresponds to a decrease in the speed of the snowmobile, and wherein the adjusting the degree of regenerative breaking corresponds to increasing the degree of regenerative breaking.

25. The method of claim 22, wherein the second indication corresponds to a decreased pitch of the snowmobile, wherein the first indication corresponds to an increase in the speed of the snowmobile, and wherein the adjusting the degree of regenerative breaking corresponds to decreasing the degree of regenerative breaking.

26. The method of claim 22, further comprising:
determining a regenerative torque slew rate multiplier, based on the first indication and the second indication; and
adjusting the degree of regenerative breaking, at a rate corresponding to the regenerative torque slew rate multiplier.

27. The method of claim 22, wherein the first indication and the second indication are received by a controller.

28. The method of claim 22, wherein the first indication and the second indication are received from an inertial measurement unit (IMU), in real time.

29. A system comprising:
one or more processors;
memory storing instructions that when executed, by the one or more processors, cause the system to perform the method of claim 22.

30. A method of disarming a snowmobile, the method comprising:
receiving a preconfigured duration of time;
determining that one or more types of user-input have not been received, for the preconfigured duration of time:
disarming the snowmobile, automatically;
receiving an indication corresponding to rearming the snowmobile; and
rearming the snowmobile.

31. The method of claim 30, wherein, prior to receiving the indication, the method further comprises:
receiving an indication corresponding to a throttle of the snowmobile being depressed; and
not moving the snowmobile.

32. The method of claim 30, wherein, after rearming the snowmobile, the method further comprises:
receiving an indication corresponding to a throttle of the snowmobile being depressed; and
moving the snowmobile.

33. The method of claim 30, wherein the indication is received from a sensor of a key switch.

34. The method of claim 33, wherein the indication is received from the sensor of the key switch, when the key switch is in a momentary start position.

35. The method of claim 30, wherein the indication is received from a press of an engine start/stop button.

36. The method of claim 30, wherein the indication is received from a weight sensor, the weight sensor corresponding to an operator seat of the snowmobile.

37. The method of claim 30, wherein disarming the snowmobile comprises blocking a signal from being sent, via a controller to an electric motor, to throttle the electric motor.

38. The method of claim 30 wherein the one or more types of user-input comprises one or more of pressing a button or turning a lever, corresponding to an increase in throttle.

39. A method of swapping batteries, the method comprising:
providing a vehicle comprising a plurality of ground engaging members, a structural frame, an electric powertrain, and a first battery assembly, the plurality of ground engaging members including an endless track positioned along a vertical centerline plane of the vehicle, a left front ski, and a right front ski, the electric powertrain being operatively coupled to the endless track to power movements of the endless track, the electric powertrain comprising an electric motor operatively coupled to the endless track, the first battery assembly being operatively and removably coupled to the electric motor, and the first battery assembly being removably coupled to the structural frame;
determining a charge level of the first battery assembly is below a predetermined threshold:
providing an indication corresponding to the charge level being below the predetermined threshold; and
in response to providing the indication, receiving a second battery assembly in replacement of the first battery assembly.

40. The method of claim 39, wherein the first battery assembly includes a first traction battery, and wherein the second battery assembly includes a second traction battery.

41. The method of claim 40, wherein the second battery assembly is operatively and removably coupled to the electric motor and removably coupled to the structural frame.

42. The method of claim 39, wherein, prior to the second battery assembly being received, and in response to providing the indication, the first battery assembly is de-coupled from the electric motor and the structural frame.
